(19) United States
(12) Patent Application Publication
(10) Pub. No.: US 2025/0317186 A1
(43) Pub. Date: Oct. 9, 2025

(54) METHOD AND DEVICE FOR BEAM RECOVERY IN MOBILE COMMUNICATION SYSTEM OF MTRP ENVIRONMENT

(71) Applicants: HYUNDAI MOTOR COMPANY, Seoul (KR); KIA CORPORATION, Seoul (KR); SEOUL NATIONAL UNIVERSITY R&DB FOUNDATION, Seoul (KR)

(72) Inventors: Gene Back Hahn, Hwaseong-si, Gyeonggi-do (KR); Young Kil Suh, Hwaseong-si, Gyeonggi-do (KR); Ui Hyun Hong, Hwaseong-si, Gyeonggi-do (KR); Bum Jun Kim, Seoul (KR); Jeonghyeon Kwon, Seoul (KR); Wan Choi, Seoul (KR)

(73) Assignees: HYUNDAI MOTOR COMPANY, Seoul (KR); KIA CORPORATION, Seoul (KR); SEOUL NATIONAL UNIVERSITY R&DB FOUNDATION, Seoul (KR)

(21) Appl. No.: 18/872,696

(22) PCT Filed: Aug. 2, 2023
(86) PCT No.: PCT/KR2023/011358

§ 371 Date: Dec. 6, 2024

(30) Foreign Application Priority Data
Aug. 2, 2022 (KR) 10-2022-0096276

(51) Int. Cl. H04B 7/06; H04B 17/309; H04W 74/0833

(52) U.S. Cl. CPC H04B 7/06952; H04B 17/346; H04W 74/0833

(57) ABSTRACT

The present disclosure relates to a method of a first TRP, and the method may comprise the steps of: when a beam failure recovery request is received from a communicating terminal, identifying whether the first TRP is connected through a backhaul to a second TRP communicating with the terminal; if the first TRP is not connected through the backhaul to the second TRP, transmitting, to the terminal, a first message including the beam indexes of candidate beams between the first TRP and the terminal; in response to the first message, receiving a first report message including beam index-related information from the terminal; and determining a beam index to be used for communication with the terminal, on the basis of the beam index-related information.

### TECHNICAL FIELD

The present disclosure relates to a communication technique, and more particularly, to a technique for beam failure recovery in a multi-transmission and reception point (MTRP) environment.

### BACKGROUND ART

A communication network (e.g. 5G communication network or 6G communication network) is being developed to provide enhanced communication services compared to the existing communication networks (e.g. long term evolution (LTE), LTE-Advanced (LTE-A), etc.). The 5G communication network (e.g. New Radio (NR) communication network) can support frequency bands both below 6 GHz and above 6 GHz. In other words, the 5G communication network can support both a frequency region 1 (FR1) and/or FR2 bands. Compared to the LTE communication network, the 5G communication network can support various communication services and scenarios. For example, usage scenarios of the 5G communication network may include enhanced Mobile BroadBand (eMBB), Ultra Reliable Low Latency Communication (URLLC), massive Machine Type Communication (mMTC), and the like.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios such as terrestrial communication, non-terrestrial communication, sidelink communication, and the like.

Meanwhile, in 5G NR, a multi-transmission and reception point (MTRP) technique refers to a technique in which a gNB communicates with a terminal using multiple TRPs that are physically separated. The MTRP technique helps solve issues with reduced quality-of-service (QOS) for cell-edge terminals far from the base station and mitigates inter-cell interference from base stations in different cells. Additionally, it contributes to providing an alternative communication path in limited environments with non-line-of-sight (NLOS) paths, in a wireless communication technology using a high frequency band such as a millimeter wave band.

In the current 3GPP standards, the MTRP technique is categorized into a coherent joint transmission (CJT) scheme and a non-coherent joint transmission (NCJT) scheme. In the CJT scheme, TRPs cooperate in a synchronized manner based on a reliable backhaul link between base stations connected to the TRPs. On the other hand, in the NCJT scheme, scheduling, precoding matrix selection, modulation, and coding schemes are determined without coordination among the multiple TRPs supporting a single terminal.

Therefore, in an MTRP environment, when a beam failure occurs in a communication link between a TRP and a terminal, it may be necessary to define a beam failure recovery procedure that also considers links between the terminal and other TRPs, along with parameters required for this procedure.

### DISCLOSURE

### Technical Problem

The present disclosure is directed to providing a method and an apparatus for beam failure recovery in a mobile communication system with an MTRP environment.

### Technical Solution

A method of a terminal, according to an exemplary embodiment of the present disclosure, may comprise: in response to occurrence of a beam failure with a first transmission and reception point (TRP) communicating with the terminal, transmitting a beam failure recovery request to the first TRP: transmitting, to a second TRP communicating with the terminal, a first message including an identifier (ID) of the first TRP and a beam failure detection (BFD) indicator; receiving, from the first TRP, a second message including respective beam indexes corresponding to candidate beams to be used between the first TRP and the terminal: measuring signal to interference plus noise ratios (SINRs) of a first link communicating with the second TRP for the respective beam indexes: in response to the first message, receiving, from the second TRP, a third message including an SINR threshold of the first link; and in response to the second message, transmitting, to the first TRP, a first report message including information related to index(es) of beam(s) satisfying the SINR threshold of the first link.

The method may further comprise: in response to existence of a third TRP communicating with the terminal, transmitting, to the third TRP, a fourth message including the ID of the first TRP and a BFD indicator; measuring SINRs of a second link communicating with the third TRP for the respective beam indexes; and in response to the fourth message, receiving, from the third TRP, a fifth message including an SINR threshold of the second link, wherein the first report message further includes information related to index(es) of beam(s) satisfying the SINR threshold of the second link.

The first report message may include an ID of the second TRP, the index(es) of beam(s) satisfying the SINR threshold of the first link, an ID of the third TRP, and the index(es) of beam(s) satisfying the SINR threshold of the second link.

The first report message may include common index(es) of the index(es) of beam(s) satisfying the SINR threshold of the first link and the index(es) of beam(s) satisfying the SINR threshold of the second link.

Each of the second message and the first report message may be transmitted and received using a radio resource control (RRC) signaling message.

When the first TRP and the second TRP are connected to a same base station, the first message may be transmitted using one of uplink control information (UCI), measurement report, or user equipment (UE) assistance information.

When the first TRP and the second TRP are connected to different base stations, the first message may be transmitted using a message based on a random access channel (RACH) access procedure.

A method of a first transmission and reception point (TRP), according to an exemplary embodiment of the present disclosure, may comprise: upon receiving a beam failure recovery request from a terminal communicating with the first TRP, checking whether the first TRP is connected to a second TRP communicating with the terminal via a backhaul; in response to the first TRP not being connected to the second TRP via a backhaul, transmitting, to the terminal, a first message including beam indexes of candidate beams between the first TRP and the terminal: in response to the first message, receiving, from the terminal, a first report message including information related to index(es) of beam(s); and determining an index of a beam to be used for communicating with the terminal based on the information related to the index(es) of beam(s).

The first report message may include an identifier (ID) of the second TRP and index(es) of at least one beam satisfying a signal to interference plus noise ratio (SINR) threshold of a first link between the second TRP and the terminal.

When a third TRP communicating with the terminal exists, the first report message may further include an ID of the third TRP ID and index(es) of at least one beam satisfying an SINR threshold of a second link between the third TRP and the terminal.

When the first report message includes two or more beam indexes, the index of the beam to be used for communicating with the terminal may be determined based on SINRs reported with the respective two or more beam indexes.

Each of the first message and the first report message may be transmitted and received using a radio resource control (RRC) signaling message.

A method of a terminal, according to an exemplary embodiment of the present disclosure, may comprise: in response to occurrence of a beam failure with a first transmission and reception point (TRP) communicating with the terminal, transmitting a beam failure recovery request to the first TRP: transmitting, to a second TRP communicating with the terminal, a first message including an identifier (ID) of the first TRP and a beam failure detection (BFD) indicator; receiving, from the first TRP, a second message including respective beam indexes corresponding to candidate beams to be used between the first TRP and the terminal: measuring signal to interference plus noise ratios (SINRs) of a first link communicating with the second TRP for the respective beam indexes: transmitting, to the second TRP, a third message including the measured SINRs for the respective beam indexes: in response to the first message, receiving, from the second TRP, a fourth message including index(es) of at least one beam; and transmitting, to the first TRP, a first report message including information related to index(es) of beam(s) based on the fourth message received from the second TRP.

The method may further comprise: in response to existence of a third TRP communicating with the terminal, transmitting, to the third TRP, a fifth message including the ID of the first TRP and a BFD indicator; measuring SINRs of a second link communicating with the third TRP for the respective beam indexes: transmitting, to the third TRP, a sixth message including the measured SINRs for the respective beam indexes; and in response to the fifth message, receiving, from the third TRP, a seventh message including index(es) of at least one beam, wherein the first report message further includes information related to index(es) of beam(s) based on the seventh message.

The first report message may include an ID of the second TRP, index(es) of beam(s) satisfying the SINR threshold of the first link, an ID of the third TRP, and index(es) of beam(s) satisfying the SINR threshold of the second link.

The first report message may include only common index(es) of the index(es) of at least one beam included in the fourth message and the index(es) of at least one beam included in the seventh message.

Each of the second message and the first report message may be transmitted and received using a radio resource control (RRC) signaling message.

When the first TRP and the second TRP are connected to a same base station, the first message may be transmitted using one of uplink control information (UCI), measurement report, or user equipment (UE) assistance information.

When the first TRP and the second TRP are connected to different base stations, the first message may be transmitted using a message based on a random access channel (RACH) access procedure.

### Advantageous Effects

Using the device and method according to the present disclosure, when a beam failure occurs in an MTRP environment, beam recovery can be performed while minimizing the impact on communication with other TRPs. In particular, when a single terminal communicates with multiple TRPs in the MTRP environment, there is an advantage of recovering a beam between a TRP where the beam failure occurred and the terminal while minimizing the impact on beams with other TRPs communicating with the terminal.

### DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a block diagram illustrating a first exemplary embodiment of communication nodes performing communication.

FIG. 4A is a block diagram illustrating a first exemplary embodiment of a transmission path.

FIG. 4B is a block diagram illustrating a first exemplary embodiment of a reception path.

FIG. 5 is a conceptual diagram illustrating a first exemplary embodiment of a system frame in a communication system.

FIG. 6 is a conceptual diagram illustrating a first exemplary embodiment of a subframe in a communication system.

FIG. 7 is a conceptual diagram illustrating a first exemplary embodiment of a slot in a communication system.

FIG. 8 is a conceptual diagram illustrating a first exemplary embodiment of a time-frequency resource in a communication system.

FIG. 9 is a signal flow diagram for a process in which three TRPs communicating with a terminal exchange identifiers according to the present disclosure.

FIG. 10 is a signal flow diagram for a process in which a beam failure is notified to adjacent TRPs when the beam failure occurs according to the present disclosure.

FIG. 11 is a signal flow diagram for a process in which an optimal beam index is selected based on indexes of beams of a TRP where a beam failure occurred according to the present disclosure.

FIG. 12 is a signal flow diagram for a process in which information on index(es) of beam(s) satisfying an SINR threshold is delivered according to the present disclosure.

FIG. 13 is a signal flow diagram for a process in which a TRP where a beam failure occurred selects a beam for beam recovery according to the present disclosure.

FIG. 14 is a sequence chart illustrating a beam failure recovery process in the MTRP CJT environment according to an exemplary embodiment of the present disclosure.

FIG. 15 is a signal flow diagram according to an exemplary embodiment in which all the procedures of FIGS. 9 to 13 are performed as being combined according to the present disclosure.

FIG. 16 is a signal flow diagram for beam failure recovery according to the present disclosure in the MTRP NCJT environment.

FIG. 17 is a signal flow diagram of beam failure recovery according to the present disclosure in the MTRP NCJT environment.

FIG. 18 is a flow chart for a process in which an adjacent TRP of a TRP where a beam failure occurred selects an optimal beam for beam failure recovery according to the present disclosure in the MTRP NCJT environment.

FIG. 19 is a signal flow diagram for a process in which a TRP where a beam failure occurred selects an optimal beam for beam failure recovery based on information received from adjacent TRPs via the terminal according to the present disclosure in the MTRP NCJT environment.

FIG. 20 is a signal flow diagram for a process in which a terminal where a beam failure occurred receives information for beam failure recovery from adjacent TRP(s) according to the present disclosure in the MTRP NCJT environment.

FIG. 21 is a signal flow diagram for a process in which a terminal where a beam failure occurred determines beam failure recovery according to the present disclosure in the MTRP NCJT environment.

FIG. 22 is a flowchart according to a procedure for determining a beam to be used for beam failure recovery when a beam failure occurred according to the present disclosure in the MTRP NCJT environment.

FIG. 23 is a flowchart for a process in which beam failure recovery is performed according to an exemplary embodiment of the present disclosure in the MTRP NCJT environment.

FIG. 24 is a signal flow diagram for a process in which a TRP where a beam failure occurred performed beam recovery according to the present disclosure in the MTRP NCJT environment.

FIG. 25 is a signal flow diagram for a process in which a terminal where a beam failure occurred performs beam failure recovery according to the present disclosure in the MTRP NCJT environment.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re) transmission’ may refer to ‘transmission’, ‘retransmission’, or ‘transmission and retransmission’, ‘(re) configuration’ may refer to ‘configuration’, ‘reconfiguration’, or ‘configuration and reconfiguration’, ‘(re)connection’ may refer to ‘connection’, ‘reconnection’, or ‘connection and reconnection’, and ‘(re) access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted. The operations according to the exemplary embodiments described explicitly in the present disclosure, as well as combinations of the exemplary embodiments, extensions of the exemplary embodiments, and/or variations of the exemplary embodiments, may be performed. Some operations may be omitted, and a sequence of operations may be altered.

Even when a method (e.g. transmission or reception of a signal) to be performed at a first communication node among communication nodes is described in exemplary embodiments, a corresponding second communication node may perform a method (e.g. reception or transmission of the signal) corresponding to the method performed at the first communication node. That is, when an operation of a user equipment (UE) is described, a base station corresponding thereto may perform an operation corresponding to the operation of the UE. Conversely, when an operation of a base station is described, a corresponding UE may perform an operation corresponding to the operation of the base station.

The base station may be referred to by various terms such as NodeB, evolved NodeB, next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and the like. The user equipment (UE) may be referred to by various terms such as terminal, device, apparatus, node, communication node, end node, access terminal, mobile terminal, station, subscriber station, mobile station, portable subscriber station, on-board unit (OBU), and the like.

In the present disclosure, signaling may be one or a combination of two or more of higher layer signaling, MAC signaling, and physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g. master information block (MIB), system information block (SIB)) and/or an RRC message. The MAC signaling may refer to an operation of transmitting and receiving a MAC control element (CE). The PHY signaling may refer to an operation of transmitting and receiving control information (e.g. downlink control information (DCI), uplink control information (UCI), or sidelink control information (SCI)).

In the present disclosure, ‘configuration of an operation (e.g. transmission operation)’ may refer to signaling of configuration information (e.g. information elements, parameters) required for the operation and/or information indicating to perform the operation. ‘configuration of information elements (e.g. parameters)’ may refer to signaling of the information elements. In the present disclosure, ‘signal and/or channel’ may refer to signal, channel, or both signal and channel, and ‘signal’ may be used to mean ‘signal and/or channel’.

A communication network to which exemplary embodiments are applied is not limited to that described below, and the exemplary embodiments may be applied to various communication networks (e.g. 4G communication networks, 5G communication networks, and/or 6G communication networks). Here, ‘communication network’ may be used interchangeably with a term ‘communication system’.

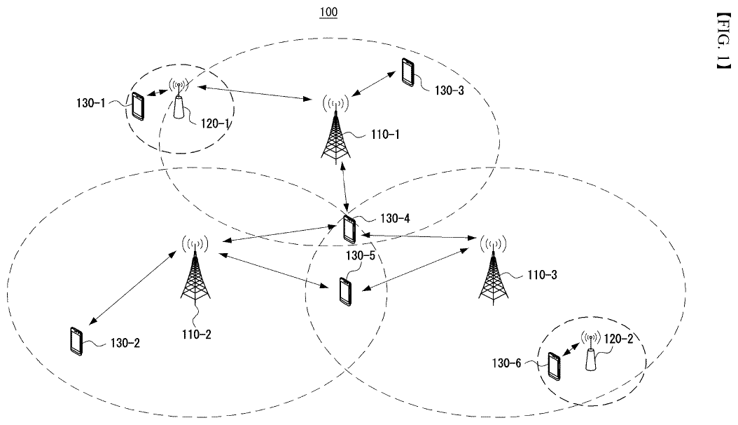

FIG. 1 is a conceptual diagram illustrating a first exemplary embodiment of a communication system.

As shown in FIG. 1, a communication system 100 may comprise a plurality of communication nodes 110-1, 110-2, 110-3, 120-1, 120-2, 130-1, 130-2, 130-3, 130-4, 130-5, and 130-6. In addition, the communication system 100 may further include a core network (e.g. a serving gateway (S-GW), a packet data network (PDN) gateway (P-GW), a mobility management entity (MME). When the communication system 100 is a 5G communication (e.g. NR system), the core network may include an access and mobility management function (AMF), a user plane function (UPF), a session management function (SMF), and the like.

The plurality of communication nodes 110 to 130 may support communication protocols (e.g. LTE communication protocol, LTE-A communication protocol, NR communication protocol, etc.) specified in 3^{rd} generation partnership project (3GPP) standards. The plurality of communication nodes 110 to 130 may support a code division multiple access (CDMA) technique, a wideband CDMA (WCDMA) technique, a time division multiple access (TDMA) technique, a frequency division multiple access (FDMA) technique, an orthogonal frequency division multiplexing (OFDM) technique, a filtered OFDM technique, a cyclic prefix OFDM (CP-OFDM) technique, a discrete Fourier transform spread OFDM (DFT-s-OFDM) technique, an orthogonal frequency division multiple access (OFDMA) technique, a single carrier FDMA (SC-FDMA) technique, a non-orthogonal multiple access (NOMA) technique, a generalized frequency division multiplexing (GFDM) technique, a filter bank multi-carrier (FBMC) technique, a universal filtered multi-carrier (UFMC) technique, a space division multiple access (SDMA) technique, or the like. Each of the plurality of communication node may have the following structure.

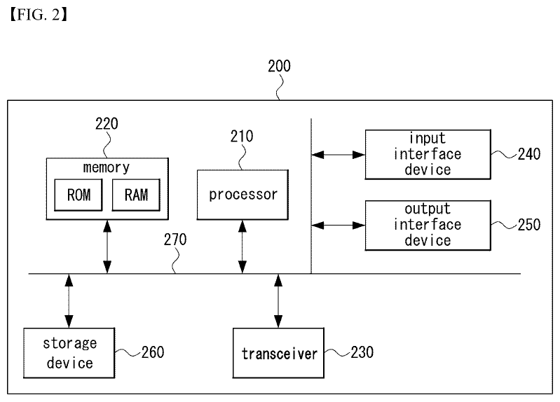

FIG. 2 is a block diagram illustrating a first exemplary embodiment of a communication node constituting a communication system.

As shown in FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, evolved Node-B (eNB), gNB, advanced base station (ABS), high reliability-base station (HR-BS), base transceiver station (BTS), radio base station, radio transceiver, access point, access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (COMP) transmission, carrier aggregation (CA) transmission, transmission in an unlicensed band, sidelink communication (e.g. device-to-device (D2D) communication, proximity services (ProSe)), Internet of Things (IoT) communication, dual connectivity (DC), and/or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control sidelink communications between the fourth terminal 130-4 and the fifth terminal 130-5, and thus the fourth terminal 130-4 and the fifth terminal 130-5 may perform the sidelink communications under control of the second base station 110-2 and the third base station 110-3, respectively.

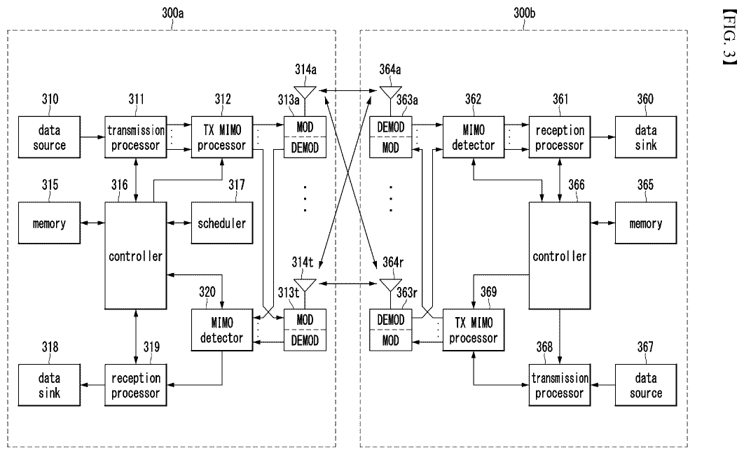

Meanwhile, communication nodes that perform communications in the communication network may be configured as follows. A communication node shown in FIG. 3 may be a specific exemplary embodiment of the communication node shown in FIG. 2.

FIG. 3 is a block diagram illustrating a first exemplary embodiment of communication nodes performing communication.

As shown in FIG. 3, each of a first communication node 300a and a second communication node 300b may be a base station or UE. The first communication node 300a may transmit a signal to the second communication node 300b. A transmission processor 311 included in the first communication node 300a may receive data (e.g. data unit) from a data source 310. The transmission processor 311 may receive control information from a controller 316. The control information may include at least one of system information, RRC configuration information (e.g. information configured by RRC signaling), MAC control information (e.g. MAC CE), or PHY control information (e.g. DCI, SCI).

The transmission processor 311 may generate data symbol(s) by performing processing operations (e.g. encoding operation, symbol mapping operation, etc.) on the data. The transmission processor 311 may generate control symbol(s) by performing processing operations (e.g. encoding operation, symbol mapping operation, etc.) on the control information. In addition, the transmission processor 311 may generate synchronization/reference symbol(s) for synchronization signals and/or reference signals.

A Tx MIMO processor 312 may perform spatial processing operations (e.g. precoding operations) on the data symbol(s), control symbol(s), and/or synchronization/reference symbol(s). An output (e.g. symbol stream) of the Tx MIMO processor 312 may be provided to modulators (MODs) included in transceivers 313a to 313t. The modulator may generate modulation symbols by performing processing operations on the symbol stream, and may generate signals by performing additional processing operations (e.g. analog conversion operations, amplification operation, filtering operation, up-conversion operation, etc.) on the modulation symbols. The signals generated by the modulators of the transceivers 313a to 313t may be transmitted through antennas 314a to 314t.

The signals transmitted by the first communication node 300a may be received at antennas 364a to 364r of the second communication node 300b. The signals received at the antennas 364a to 364r may be provided to demodulators (DEMODs) included in transceivers 363a to 363r. The demodulator (DEMOD) may obtain samples by performing processing operations (e.g. filtering operation, amplification operation, down-conversion operation, digital conversion operation, etc.) on the signals. The demodulator may perform additional processing operations on the samples to obtain symbols. A MIMO detector 362 may perform MIMO detection operations on the symbols. A reception processor 361 may perform processing operations (e.g. de-interleaving operation, decoding operation, etc.) on the symbols. An output of the reception processor 361 may be provided to a data sink 360 and a controller 366. For example, the data may be provided to the data sink 360 and the control information may be provided to the controller 366.

On the other hand, the second communication node 300b may transmit signals to the first communication node 300a. A transmission processor 368 included in the second communication node 300b may receive data (e.g. data unit) from a data source 367 and perform processing operations on the data to generate data symbol(s). The transmission processor 368 may receive control information from the controller 366 and perform processing operations on the control information to generate control symbol(s). In addition, the transmission processor 368 may generate reference symbol(s) by performing processing operations on reference signals.

A Tx MIMO processor 369 may perform spatial processing operations (e.g. precoding operations) on the data symbol(s), control symbol(s), and/or reference symbol(s). An output (e.g. symbol stream) of the Tx MIMO processor 369 may be provided to modulators (MODs) included in the transceivers 363a to 363t. The modulator may generate modulation symbols by performing processing operations on the symbol stream, and may generate signals by performing additional processing operations (e.g. analog conversion operation, amplification operation, filtering operation, up-conversion operations) on the modulation symbols. The signals generated by the modulators of the transceivers 363a to 363t may be transmitted through the antennas 364a to 364t.

The signals transmitted by the second communication node 300b may be received at the antennas 314a to 314r of the first communication node 300a. The signals received at the antennas 314a to 314r may be provided to demodulators (DEMODs) included in the transceivers 313a to 313r. The demodulator may obtain samples by performing processing operations (e.g. filtering operation, amplification operation, down-conversion operation, digital conversion operation) on the signals. The demodulator may perform additional processing operations on the samples to obtain symbols. A MIMO detector 320 may perform a MIMO detection operation on the symbols. The reception processor 319 may perform processing operations (e.g. de-interleaving operation, decoding operation, etc.) on the symbols. An output of the reception processor 319 may be provided to a data sink 318 and the controller 316. For example, the data may be provided to the data sink 318 and the control information may be provided to the controller 316.

Memories 315 and 365 may store the data, control information, and/or program codes. A scheduler 317 may perform scheduling operations for communication. The processors 311, 312, 319, 361, 368, and 369 and the controllers 316 and 366 shown in FIG. 3 may be the processor 210 shown in FIG. 2, and may be used to perform methods described in the present disclosure.

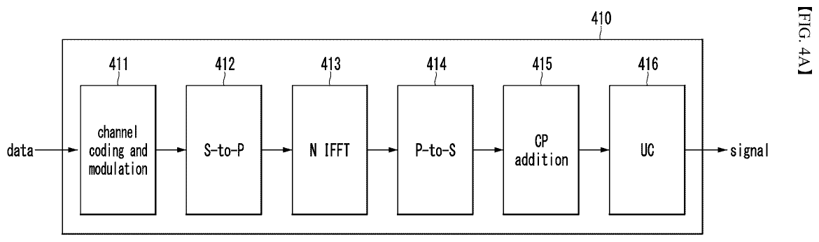

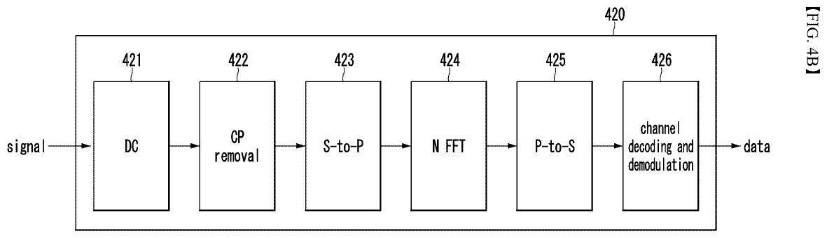

FIG. 4A is a block diagram illustrating a first exemplary embodiment of a transmission path, and FIG. 4B is a block diagram illustrating a first exemplary embodiment of a reception path.

As shown in FIGS. 4A and 4B, a transmission path 410 may be implemented in a communication node that transmits signals, and a reception path 420 may be implemented in a communication node that receives signals. The transmission path 410 may include a channel coding and modulation block 411, a serial-to-parallel (S-to-P) block 412, an N-point inverse fast Fourier transform (N-point IFFT) block 413, a parallel-to-serial (P-to-S) block 414, a cyclic prefix (CP) addition block 415, and up-converter (UC) 416. The reception path 420 may include a down-converter (DC) 421, a CP removal block 422, an S-to-P block 423, an N-point FFT block 424, a P-to-S block 425, and a channel decoding and demodulation block 426. Here, N may be a natural number.

In the transmission path 410, information bits may be input to the channel coding and modulation block 411. The channel coding and modulation block 511 may perform a coding operation (e.g. low-density parity check (LDPC) coding operation, polar coding operation, etc.) and a modulation operation (e.g. Quadrature Phase Shift Keying (OPSK), Quadrature Amplitude Modulation (QAM), etc.) on the information bits. An output of the channel coding and modulation block 411 may be a sequence of modulation symbols.

The S-to-P block 412 may convert frequency domain modulation symbols into parallel symbol streams to generate N parallel symbol streams. N may be the IFFT size or the FFT size. The N-point IFFT block 413 may generate time domain signals by performing an IFFT operation on the N parallel symbol streams. The P-to-S block 414 may convert the output (e.g., parallel signals) of the N-point IFFT block 413 to serial signals to generate the serial signals.

The CP addition block 415 may insert a CP into the signals. The UC 416 may up-convert a frequency of the output of the CP addition block 415 to a radio frequency (RF) frequency. Further, the output of the CP addition block 415 may be filtered in baseband before the up-conversion.

The signal transmitted from the transmission path 410 may be input to the reception path 420. Operations in the reception path 420 may be reverse operations for the operations in the transmission path 410. The DC 421 may down-convert a frequency of the received signals to a baseband frequency. The CP removal block 422 may remove a CP from the signals. The output of the CP removal block 422 may be serial signals. The S-to-P block 423 may convert the serial signals into parallel signals. The N-point FFT block 424 may generate N parallel signals by performing an FFT algorithm. The P-to-S block 425 may convert the parallel signals into a sequence of modulation symbols. The channel decoding and demodulation block 426 may perform a demodulation operation on the modulation symbols and may restore data by performing a decoding operation on a result of the demodulation operation.

In FIGS. 4A and 4B, discrete Fourier transform (DFT) and inverse DFT (IDFT) may be used instead of FFT and IFFT. Each of the blocks (e.g. components) in FIGS. 4A and 4B may be implemented by at least one of hardware, software, or firmware. For example, some blocks in FIGS. 4A and 4B may be implemented by software, and other blocks may be implemented by hardware or a combination of hardware and software. In FIGS. 4A and 4B, one block may be subdivided into a plurality of blocks, a plurality of blocks may be integrated into one block, some blocks may be omitted, and blocks supporting other functions may be added.

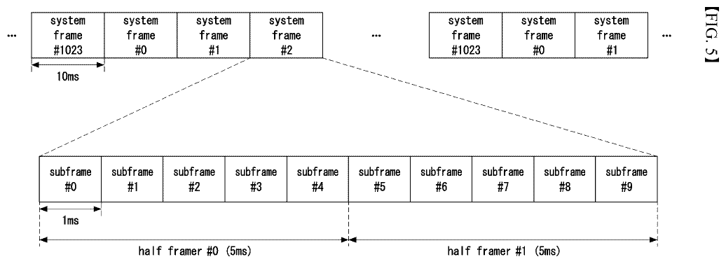

FIG. 5 is a conceptual diagram illustrating a first exemplary embodiment of a system frame in a communication system.

As shown in FIG. 5, time resources in the communication system may be divided on a frame basis. For example, system frames of the communication system may be configured continuously in the time domain. The length of the system frame may be 10 millisecond (ms). A system frame number (SFN) may be set to one of #0 to #1023. In this case, 1024 system frames may be repeated on the time domain of the communication system. For example, an SFN of a system frame after the system frame #1023 may be #0.

One system frame may include two half frames. The length of one half frame may be 5 ms. A half frame located at a starting region of the system frame may be referred to as ‘half frame #0’, and a half frame located at an ending region of the system frame may be referred to as ‘half frame #1’. One system frame may include 10 subframes. The length of one subframe may be 1 ms. 10 subframes within one system frame may be referred to as subframes #0- #9.

FIG. 6 is a conceptual diagram illustrating a first exemplary embodiment of a subframe in a communication system.

As shown in FIG. 6, one subframe may include n slots, and n may be a natural number. Accordingly, one subframe may consist of one or more slots.

FIG. 7 is a conceptual diagram illustrating a first exemplary embodiment of a slot in a communication system.

As shown in FIG. 7, one slot may include one or more symbols. For example, one slot shown in FIG. 7 may include 14 symbols. The length of slot may vary according to the number of symbols included in a slot and the length of symbol. Alternatively, the length of slot may vary according to a numerology.

The numerology applied to physical signals and channels in a communication system may be variable. The numerology may be adjusted to meet various technical requirements of the communication system. In a communication system where a cyclic prefix (CP)-based OFDM waveform technology is applied, the numerology May include a subcarrier spacing and a CP length (or CP type). Table 1 may illustrate a first exemplary embodiment of a method for configuring numerologies for a CP-OFDM-based communication system. Depending on a frequency band in which the communication system operates, at least some of the numerologies in Table 1 may be supported. Additionally, the communication system may support numerologies not listed in Table 1.

TABLE 1

| | Subcarrier spacing | | | | | |
|---|---|---|---|---|---|---|
| | 15 | 30 | 60 | 120 | 240 | 480 |
| | kHz | kHz | kHz | kHz | kHz | kHz |
| OFDM symbol | 66.7 | 33.3 | 16.7 | 8.3 | 4.2 | 2.1 |
| length [μs] | | | | | | |
| CP length [μs] | 4.76 | 2.38 | 1.19 | 0.60 | 0.30 | 0.15 |
| Number of | 14 | 28 | 56 | 112 | 224 | 448 |
| OFDM symbols | | | | | | |
| within 1 ms | | | | | | |

When a subcarrier spacing is 15 kHz (e.g. μ=0), the length of slot may be 1 ms. In this case, one system frame may include 10 slots. When a subcarrier spacing is 30 kHz (e.g. μ=1), the length of slot may be 0.5 ms. In this case, one system frame may include 20 slots.

When a subcarrier spacing is 60 kHz (e.g. μ=2), the length of slot may be 0.25 ms. In this case, one system frame may include 40 slots. When a subcarrier spacing is 120 kHz (e.g. μ=3), the length of slot may be 0.125 ms. In this case, one system frame may include 80 slots. When a subcarrier spacing is 240 kHz (e.g. μ=4), the length of slot may be 0.0625 ms. In this case, one system frame may include 160 slots.

The symbol may be configured as a downlink (DL) symbol, flexible (FL) symbol, or uplink (UL) symbol. A slot composed of only DL symbols may be referred to as a ‘DL slot’, a slot composed of only FL symbols may be referred to as a “FL slot”, and a slot composed of only UL symbols may be referred to as a ‘UL slot’.

A slot format may be semi-statically configured through higher-layer signaling (e.g. RRC signaling). Information indicating a semi-static slot format may be included in system information, and the semi-static slot format may be configured cell-specifically. Additionally, a semi-static slot format may be further configured for each terminal through terminal-specific higher-layer signaling (e.g. RRC signaling). Flexible symbols in the cell-specific slot format may be overridden to be downlink symbols or uplink symbols through terminal-specific higher-layer signaling. Furthermore, a slot format may be dynamically indicated through physical layer signaling (e.g. slot format indicator (SFI) included in DCI). The semi-statically configured slot format may be overridden by the dynamically indicated slot format. For example, flexible symbols configured semi-statically may be overridden to be downlink symbols or uplink symbols by the SFI.

Reference signals may include Channel State Information-Reference Signal (CSI-RS), Sounding Reference Signal (SRS), Demodulation-Reference Signal (DM-RS), and Phase Tracking-Reference Signal (PT-RS). Channels may include Physical Broadcast Channel (PBCH), Physical Downlink Control Channel (PDCCH), Physical Downlink Shared Channel (PDSCH), Physical Uplink Control Channel (PUCCH), PUSCH (Physical Uplink Shared Channel), PSCCH (Physical Sidelink Control Channel), and PSSCH (Physical Sidelink Shared Channel). In the present disclosure, a control channel may refer to PDCCH, PUCCH, or PSCCH, and a data channel may refer to PDSCH, PUSCH, or PSSCH.

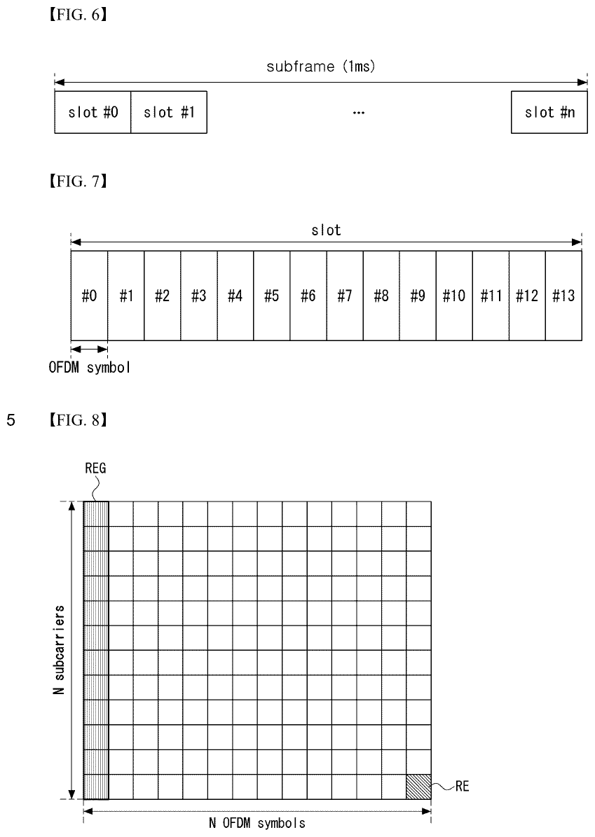

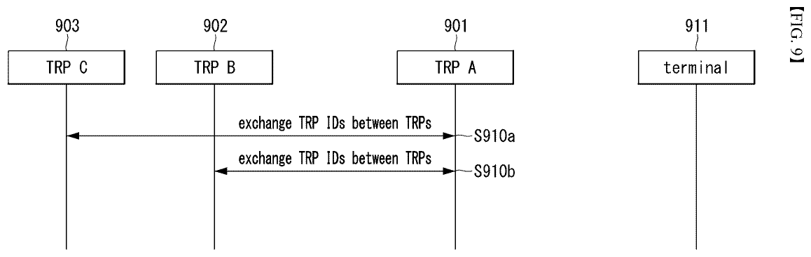

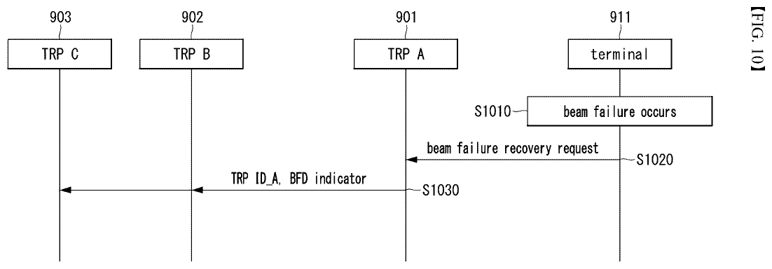

FIG. 8 is a conceptual diagram illustrating a first exemplary embodiment of a time-frequency resource in a communication system.

As shown FIG. 8, a resource composed of one OFDM symbol on the time axis and one subcarrier on the frequency axis may be defined as a ‘resource element (RE)’. A resource composed of one OFDM symbol on the time axis and K subcarriers on the frequency axis may be defined as a ‘resource element group (REG)’. The REG may include K REs. The REG may be used as a basic unit of resource allocation in the frequency domain. K may be a natural number. For example, K may be 12. N may be a natural number. In the slot shown in FIG. 7, N may be 14. N OFDM symbols may be used as a basic unit of resource allocation in the time domain.

In the present disclosure, an RB may refer to a common RB (CRB). Alternatively, an RB may refer to a physical RB (PRB) or a virtual RB (VRB). In a communication system, a CRB may refer to an RB that constitutes a set of contiguous RBs (e.g. a common RB grid) based on a reference frequency (e.g. point A). A carrier and/or bandwidth part may be mapped onto the common RB grid. That is, a carrier and/or bandwidth part may be configured with CRB(s). The RBs or CRBs that constitute a bandwidth part may be referred to as PRBs, and a CRB index may be appropriately converted to a PRB index within the bandwidth part.

Downlink data may be transmitted through a PDSCH. A base station may transmit configuration information (e.g. scheduling information) of the PDSCH to a terminal through a PDCCH. The terminal may obtain the configuration information of the PDSCH by receiving the PDCCH (e.g. Downlink Control Information (DCI)). For example, the configuration information of the PDSCH may include a Modulation Coding Scheme (MCS) used for transmission/reception of the PDSCH, time resource information of the PDSCH, frequency resource information of the PDSCH, and feedback resource information for the PDSCH. The PDSCH may refer to a radio resource where the downlink data is transmitted and received. Alternatively, the PDSCH may refer to the downlink data itself. The PDCCH may refer to a radio resource where the downlink control information (e.g. DCI) is transmitted and received. Alternatively, the PDCCH may refer to the downlink control information itself.

The terminal may perform a monitoring operation for the PDCCH to receive the PDSCH transmitted from the base station. The base station may notify the terminal of configuration information for the PDCCH monitoring operation using a higher-layer message (e.g. Radio Resource Control (RRC) message). The configuration information for the PDCCH monitoring operation may include Control Resource Set (CORESET) information and search space information.

The CORESET information may include PDCCH DMRS information, PDCCH precoding information, and PDCCH occasion information, and the like. A PDCCH DMRS may be a DMRS used for demodulating a PDCCH. A PDCCH occasion refers to a region where a PDCCH may potentially exist, meaning it is a region where DCI can be transmitted. A PDCCH occasion may also be referred to as a PDCCH candidate. The PDCCH occasion information may include time resource information and frequency resource information for the PDCCH occasion. In the time domain, the length of the PDCCH occasion may be indicated in symbol units. In the frequency domain, the size of the PDCCH occasion can be indicated in RB units (e.g. in PRB units or CRB units).

The search space information may include a CORESET identifier (ID) associated with a search space, a periodicity of PDCCH monitoring, and/or an offset of PDCCH monitoring. The periodicity and offset of PDCCH monitoring may each be indicated in slot units. Additionally, the search space information may further include an index of a symbol where the PDCCH monitoring operation starts.

The base station may configure Bandwidth Part(s) (BWP(s)) for downlink communication. The BWP(s) may be configured differently for each terminal. The base station may notify the terminal of BWP configuration information using higher-layer signaling. The higher-layer signaling may refer to a transmission operation of system information and/or a transmission operation of RRC message(s). The number of BWPs configured for a single terminal may be one or more. The terminal may receive the BWP configuration information from the base station and identify the configured BWP(s) based on the received configuration information. When multiple BWPs are configured for downlink communication, the base station may activate one or more BWPs from among the multiple BWPs. The base station may transmit configuration information of the activated BWP(s) to the terminal using at least one of higher-layer signaling, Medium Access Control (MAC) Control Element (CE), or DCI. The base station may perform downlink communication using the activated BWP(s). The terminal may identify the activated BWP(s) by receiving the configuration information from the base station and perform downlink reception operations on the activated BWP(s).

Meanwhile, in 5G NR, a multi-transmission and reception point (MTRP) technique refers to a technique in which a gNB communicates with a terminal using multiple TRPs that are physically separated. The MTRP technique helps solve issues with reduced quality-of-service (QOS) for cell-edge terminals far from the base station and mitigates inter-cell interference from base stations in different cells. Additionally, it contributes to providing an alternative communication path in limited environments with non-line-of-sight (NLOS) paths, in a wireless communication technology using a high frequency band such as a millimeter wave band.

In the current 3GPP standards, the MTRP technique is categorized into a coherent joint transmission (CJT) scheme and a non-coherent joint transmission (NCJT) scheme. In the CJT scheme, TRPs cooperate in a synchronized manner based on a reliable backhaul link between base stations connected to the TRPs. On the other hand, in the NCJT scheme, scheduling, precoding matrix selection, modulation, and coding schemes are determined without coordination among the multiple TRPs supporting a single terminal.

In order to support MTRP technology in the 5G NR standards, discussions are being conducted on various aspects such as PDCCH, PUCCH and PUSCH enhancement, inter-cell operation, and beam management for MTRP. In relation to beam management among these aspects, an agreement has been reached on a method for performing beam indications for multiple beams to a terminal in an MTRP environment and a process for the terminal to receive multiple beams and report their performances.

However, most of the discussions so far have been limited to basic configurations for beam management processes in communications between multiple TRPs and the terminal in the MTRP environment, or to signaling required to support beam management in the MTRP environment. However, there is still a lack of detailed procedures for the beam management process and considerations for beam failure situations in the MTRP environment. In particular, a situation where the terminal can no longer exchange information with a TRP experiencing a beam failure in the MTRP environment has not yet been discussed. For example, in an environment where the terminal communicates with multiple TRPs, if a beam failure recovery process is performed independently by considering only the link between the terminal and the TRP where a beam failure occurred, the links between the terminal and other TRPs might not be taken into account, potentially resulting in performance degradation on those links. As a result, a beam selected as optimal through the beam failure recovery process, focusing only on the link where the beam failure occurred, may not guarantee optimal communication with other TRPs. Therefore, in the MTRP environment, if a beam failure occurs on the link between a TRP and the terminal, it may be necessary to define a beam failure recovery procedure that also accounts for links with other TRPs and the parameters required for such procedures.

In addition, the 3GPP is discussing various situations in which MTRP should be considered. For example, it has been agreed that all intra- and inter-cell MTRP schemes specified in an unified TCI framework extension should be considered. In addition, it has been agreed that the existing TCI field of DCI format 1_1/1_2 is used to indicate multiple joint/DL/UL TCI states for a CC/BWP or a CC/BWP set of a CC list, at least in the unified TCI framework extension for single DCI-based MTRP. In addition, it has been agreed that further solutions for TCI state updates should be considered to extend the unified TCI framework for M-DCI based MTRP. The above-described agreements do not provide specific methods for MTRP support.

In 5G NR, which has been standardized so far, communication procedures utilizing MTRP are supported to improve the performance and efficiency of MIMO. The CJT or NCJT scheme in the MTRP technique may be determined according to an environment of a cell where the current TRPs exist, backhaul link connectivity, and/or the like. In addition, depending on which scheme is selected between the CJT and NCJT scheme in the MTRP technique, it may be determined whether multiple TRPs cooperate to support one terminal (CJT scheme) or whether each TRP independently supports one terminal (NCJT scheme).

Recently, discussions have begun in the 3GPP standard meetings regarding scenarios where a terminal in the MTRP environment is equipped with multiple panels. When the terminal uses multiple panels, it can form multiple reception beams simultaneously for beams transmitted by different TRPs, enabling efficient information reception. The present disclosure considers a scenario where a multi-panel terminal communicates with multiple TRPs in the MTRP environment. Specifically, it addresses a case where the terminal allocates one TRP to each of its panels (e.g. TRP A-UE panel A, TRP B-UE panel B, TRP C-UE panel C) and must perform beam failure recovery when a beam failure occurs at one of the TRPs during communication.

The present disclosure may also be applied to cases other than those described above. For example, the terminal needs to measure signal-to-interference-plus-noise ratios (SINRs) of signals received from all the TRPs. In this case, multiple TRPs may be allocated to a single panel of the terminal, or multiple panels of the terminal may be allocated to a single TRP. The present disclosure may also be applied when measuring SINRs of signals received from the TRPs based on the relationships established between the terminal's panels and the TRPs. As described above, the terminal may have multi-panels, and one or more panels may be mapped to one or more TRPs. In this case, a TRP with activated beam failure detection (BFD) and a UE panel mapped to it may independently proceed with a beam failure recovery process, selecting a beam through that process. When BFD is activated and beam failure recovery and beam selection are performed accordingly, the beam selected through the recovery process may not guarantee optimal performance from the terminal's perspective, which simultaneously receives multiple beams from different TRPs. Furthermore, while the beam selected through the beam failure recovery process is a beam that may exhibit optimal performance when considering only the link between the TRP and the terminal, there is a possibility that it may be a beam that acts as a high-interference beam from the perspective of other TRPs. This may cause a situation where other TRPs need to perform beam failure recovery.

In the present disclosure, when a beam failure occurs on a communication link between a TRP and a terminal in the MTRP environment, and a beam failure recovery process is initiated, the terminal may first identify the SINRs of signals received from other TRPs it is communicating with during the recovery process. The present disclosure proposes a beam failure recovery procedure in which the terminal or TRP considers the performance of communication links between the terminal and other TRPs. The present disclosure provides a procedure for exchanging information, such as BFD activation information and information on beams with degraded performance from the perspective of other TRPs, either via a backhaul (CJT scheme) or using the terminal as an intermediate forwarder (NCJT scheme). Furthermore, the present disclosure proposes a beam failure recovery process to address the limitation of the existing MTRP environment, where each TRP operates independently without accounting for the performance of other TRPs.

In the following description, the present disclosure considers scenarios in an MTRP environment where three TRPs (e.g., TRP A, TRP B, and TRP C) support a single terminal equipped with multiple panels. For simplicity, three TRPs will be used as an example. However, the present disclosure is also applicable to scenarios where two or more than three TRPs support a single terminal.

In the present disclosure, for a scenario where a terminal is communicating with three TRPs and a beam failure (BF) occurs on the communication link between the terminal and TRP A, a procedure is proposed to recover from the BF, taking into account the performance of communication links between the terminal and TRPs B and C. Furthermore, although operations according to the present disclosure will be described assuming a downlink environment, the present disclosure may also be extended to apply to a uplink environment.

Specifically, the present disclosure describes a process of delivering information on the TRP where the beam failure occurs to other TRPs communicating with the terminal in the CJT and NCJT environments. Additionally, the present disclosure describes a procedure in which the terminal, during beam failure recovery with the TRP where the beam failure occurred, identifies changes in the SINRs of respective beams formed by the failed TRP, which are measured based on signals received from other TRPs. Furthermore, the present disclosure describes a final beam selection procedure, taking into account the SINRs measured for other TRPs.

First, a case may be assumed where a beam failure occurs on a beam link between the TRP A and the UE panel A of the terminal with multiple panels. Additionally, it may be assumed that the terminal establishes communication links between the TRP B and the UE panel B, as well as between the TRP C and the UE panel C. Under these assumptions, the TRP A may need to perform beam failure recovery with the UE panel A of the terminal. Therefore, the TRP A may deliver information on the beam failure to the TRP B and TRP C. The TRP A may identify SINRs between the terminal and the TRP B and TRP C for indexes of beams formed for the UE panel A. For example, the terminal or TRP B may measure the SINR between the TRP B and the terminal, and the terminal or TRP B may directly report (or forward) information on the SINR to the TRP A. Similarly, the terminal or TRP C may measure the SINR between the TRP C and the terminal, and the terminal or TRP C may directly report (or forward) information on the SINR to the TRP A.

Based on the SINR between the TRP B and the terminal and the SINR between the TRP C and the terminal, the TRP A may identify the SINRs of the communication links between the TRP B and UE panel B, and between the TRP C and UE panel C, respectively. Then, index(es) of beam(s) of the TRP A that satisfy an SINR threshold for the communication link between the TRP B and UE panel B may be delivered from the TRP B to the TRP A. Similarly, index(es) of beam(s) of the TRP A that satisfy an SINR threshold for the communication link between the TRP C and UE panel C may be delivered from the TRP C to the TRP A. Accordingly, the TRP A may select a beam with the highest SINR on the communication link between itself and the terminal among the index(es) of beam(s) delivered from the TRP B and TRP C. If the above-described process is performed in the CJT environment, information transfer between the TRPs may be performed via a backhaul, and if the above-described process is performed in the NCJT environment, information transfer therebetween may be performed via the terminal.

In the methods proposed in the present disclosure, the information transfer scheme may vary depending on whether all the TRPs are connected to the same base station or different base stations. For example, when the TRP A, TRP B, and TRP C are connected to the same base station, all the TRPs may utilize RRC signaling schemes. On the other hand, when at least one of the TRP A, TRP B, and TRP C is connected to another base station, the terminal may be assumed to be RRC-connected with a base station connected to the TRP A because the terminal can be RRC-connected only with one base station. In this case, the terminal may be regarded as being multi-connected to the base stations connected to the TRP B and TRP C through a signaling radio bearer 3 (SRB3). The terminal and the base stations connected to the TRP B and TRP C may exchange information such as SN RRC reconfiguration, SN RRC reconfiguration complete, SN measurement report, and SN UE assistance information through SRB3.

### (1) Beam Failure Recovery Procedure in MTRP CJT Environment

In the present disclosure, the terms ‘terminal’ and ‘UE’ are used interchangeably. A terminal may be understood as a type of UE, and conversely, a UE may be understood as a type of terminal. The UE or terminal may include at least some of the components described in FIG. 2 or may have the same components. As another example, the UE or terminal may have additional components in addition to the components described in FIG. 2. For example, the UE or terminal may further include various sensors, power devices, and/or interface devices for interfacing with other external devices. When the terminal or UE according to the present disclosure includes at least some of the components described in FIG. 2, UE panels may be included in the transceiver 230. Accordingly, the transceiver 230 may perform configurations and operations for establishing the communication links with TRPs using a plurality of UE panels.

The TRPs described below may also include at least some of the components described in FIG. 2 or may have the same components. As another example, the TRPs may include other components in addition to the components described in FIG. 2. For example, each of the TRPs may further include at least one of a component for establishing a backhaul link with a base station and/or a backhaul link for directly connecting to another TRP.

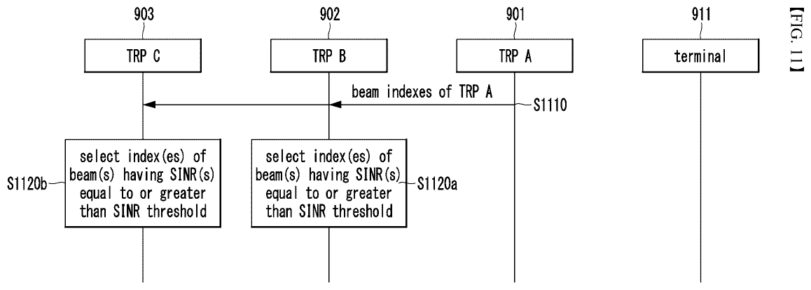

The present disclosure assumes an environment in which three TRPs (e.g. TRP A, TRP B, and TRP C) support a single terminal with multiple panels in the MTRP environment. In this case, a situation is considered where a beam failure occurs on a communication link between the TRP A and the UE panel A and beam failure recovery therefor is performed. The following description in FIGS. 9 to 13 assumes the CJT environment.

In the MTRP environment according to the present disclosure, since the terminal communicates with multiple TRPs, there may be a situation where a beam failure occurs only for a specific TRP, not all TRPs. In this case, if the terminal independently performs a beam failure recovery procedure with the TRP in which the beam failure occurred, the terminal simultaneously communicates with other TRPs in which a beam failure did not occur, and thus performance degradation may occur on communication links previously established with the other TRPs.

In order to prevent such performance degradation, when performing beam failure recovery between the TRP and the terminal, methods according to the present disclosure consider the communication performances between other TRPs and the terminal. Therefore, even if a beam failure occurs in one TRP, a process is needed to transmit information that the beam failure occurs in the TRP to other TRPs and to perform beam failure recovery considering the communication performances of other TRPs.

Accordingly, FIG. 9 to be described below may correspond to a process in which the TRP A, TRP B, and TRP C communicating with the common terminal identify each other's TRP IDs via the backhaul between the TRPs or between the base stations connected to the TRPs to support the single common terminal.

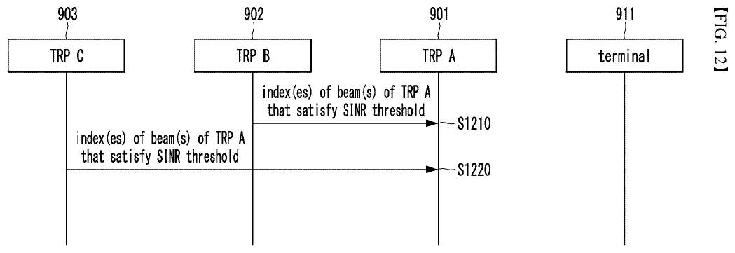

In addition, FIG. 10 to be described below may correspond to a process in which the TRP A transmits information on the beam failure occurring on the communication link it established with the UE panel A to the TRP B and TRP C via the backhaul between the TRPs or between the base stations connected to the TRPs.

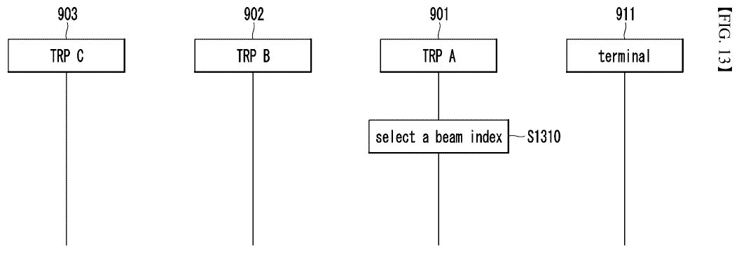

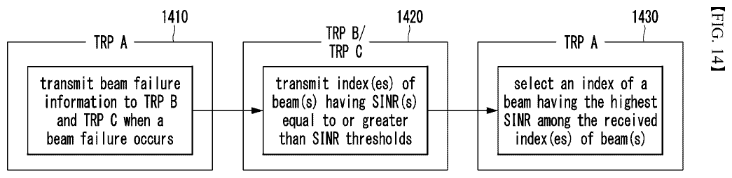

FIG. 11 to be described below may correspond to a process in which the TRP A transmits, to the TRP B and TRP C, indexes of its own candidate beams to be used in the beam failure recovery process with the UE panel A, via the backhaul between the TRPs or between the base stations connected to the TRPs, and the TRP B and TRP C measure SINRs of the communication links established with the UE panel B and UE panel C, respectively, with respect to the candidate beams of the TRP A. FIG. 12 to be described below may correspond to a process in which the TRP B and TRP C select index(es) of beam(s) of the TRP A that have an SINR equal to or higher than their SINR thresholds based on the measured SINRs for the candidate beams of the TRP A identified in the process of FIG. 11 and then transmit information on the selected beam index(es) to the TRP A via the backhaul between the TRPs or between the base stations connected to the TRPs. Finally, FIG. 13 to be described below may correspond to a process in which the TRP A selects a beam with the highest SINR among the beam(s) indicated by the index(es) received from the TRP B and TRP C through the process of FIG. 12.

In summary, FIGS. 9 and 10 may correspond to processes in which the TRP A informs the TRP B and TRP C of information on its beam failure on the communication link between the TRP A and UE panel A, and FIGS. 11 and 12 may correspond to processes in which among indexes of candidate beams formed by the TRP A with the UE panel A, the TRP B and TRP C select index(es) of beam(s) of the TRP A that satisfy the SINR thresholds for the communication links previously established between them and the UE panel B and UE panel C, and deliver information on the selected beam index(es) to the TRP A. FIG. 13 may correspond to a process in which the TRP A, where the beam failure occurred, selects an optimal beam by considering the performance of its own communication link and the performance of the communication links between other TRPs and the terminal for reliable communication of all the TRPs communicating with the terminal in the future when performing the beam failure recovery process.

Hereinafter, more detailed description will be made with reference to the drawings.

FIG. 9 is a signal flow diagram for a process in which three TRPs communicating with a terminal exchange identifiers according to the present disclosure.

As shown in FIG. 9, a TRP A 901, TRP B 902, and TRP C 903 are illustrated, and the TRPs 901 to 903 may be TRPs communicating with a terminal 911. In addition, it may be assumed that the terminal has three or more different panels so that it can communicate with the different TRPs 901 to 903. For example, it may be assumed that the terminal 911 communicates with the TRP A 901 using a panel A (not shown), communicates with the TRP B 902 using a panel B (not shown), and communicates with the TRP C 903 using a panel C (not shown).

As described above, the TRPs 901 to 903 according to the present disclosure may be connected via the backhaul between the TRPs or between base stations connected to the TRPs. Each of the TRPs 901 to 903 may know in advance that the terminal 911 is communicating with other TRPs. Therefore, the TRPs 901 to 903 may need to know which TRPs the terminal 911 is communicating with. According to an exemplary embodiment of the present disclosure, the MTRP CJT environment is assumed. Therefore, communication between the TRPs may be possible directly or via the backhaul between the TRPs through at least one base station.

In step S910a, the TRP A 901 communicating with the terminal 911 may exchange TRP identifiers (IDs) with the TRP B 902 that is another TRP communicating with the terminal 911 via the backhaul connected either directly or through base stations. In other words, in step S910a, the TRP A 901 may transmit information on its TRP ID to the TRP B 902 via the backhaul connected either directly or through base stations. In addition, in step S910a, the TRP A 901 may receive information on a TRP ID of the TRP B from the TRP B 902 using the backhaul.

In addition, in step S910b, the TRP A 901 communicating with the terminal 911 may exchange TRP IDs with the TRP C 903 that is another TRP communicating with the terminal 911 via the backhaul connected either directly or through base stations. In other words, in step S910b, the TRP A 901 may transmit information on its TRP ID to the TRP C 903 via the backhaul connected either directly or through base stations. In addition, in step S910b, the TRP A 901 may receive information on a TRP ID of the TRP C from the TRP C 903 using the backhaul.

In FIG. 9, the form in which steps S910a and S910b are sequentially performed is exemplified. However, in an actual implementation, steps S910a and S910b may be performed simultaneously. As another example, in an actual implementation, step S910b may be performed first and step S910a may be performed later.

The information on the TRP IDs exchanged between the TRPs as described in FIG. 9 may be exemplified as in Table 2 below.

TABLE 2

| | TRP ID information |
|---|---|
| TRP A ↔ TRP B | TRP ID_A ↔ TRP ID_B |
| TRP A ↔ TRP C | TRP ID_A ↔ TRP ID_C |
| TRP B ↔ TRP C | TRP ID_B ↔ TRP ID_C |

Meanwhile, information on the TRP IDs exchanged between the TRPs through the process of FIG. 9 may be utilized when a beam failure occurs on a communication link between a specific TRP and the terminal 911. For example, the specific TRP may inform other TRPs of the information that its beam failure occurred. In addition, the specific TRP where the beam failure occurred may utilize the TRP IDs for transmitting and receiving necessary parameters during a beam failure recovery procedure. While the process in FIG. 9 considers the CJT environment where TRPs are connected via the backhaul either between the TRPs or between base stations connected to them, a case may also be considered where the TRP A 901, TRP B 902, and TRP C 903 exchange their TRP IDs via the terminal 911 in the NJCT environment and subsequently establish a backhaul between the TRPs or between base stations connected to the TRPs.

The exemplary embodiment of FIG. 9 described above may be used in combination with at least one of other exemplary embodiments described below.

FIG. 10 is a signal flow diagram for a process in which a beam failure is notified to adjacent TRPs when the beam failure occurs according to the present disclosure.

As shown in FIG. 10, the TRP A 901, TRP B 902, TRP C 903, and terminal 911 are illustrated as described in FIG. 9 above. A procedure of FIG. 10 described below will be described assuming the CJT environment described in FIG. 9 above.

In step S1010, the terminal 911 may recognize that a beam failure occurs on the communication link between the TRP A and UE panel A. For example, a beam failure may occurs when the terminal 911 declares the beam failure if the number of beam failure instances (BFI) exceeds the maximum allowable number for a communication link established between the terminal 911 and a specific TRP. Therefore, the terminal 911 may be in a situation where a beam failure recovery procedure needs to be performed. In other words, occurrence of the beam failure may correspond to a situation where BFI_COUNTER>=beamFailureInstanceMaxCount.

Here, BFI indicates a situation where a block error rate (BLER) is equal to or greater than a certain threshold, and a count value may be increases by 1 for each BFI. If the count value does not increase within a certain time after the count value increases by 1, BFI_COUNTER may be reset to zero (0). When BFI_COUNTER is reset as described above, it may be interpreted that no more BFIs have occurred.

If a beam failure occurs as above, the terminal 911 may transmit a beam failure recovery request signal (or message) to the TRP A 901 in step S1020. The beam failure recovery request signal (or message) may transmit beam failure recovery request information to the TRP A 901 through BeamFailureRecoveryConfig including information such as rach-ConfigBFR, rsrp-ThresholdSSB and/or candidateBeamRSList of RRC signaling.

The TRP A 901 may attempt beam failure recovery based on the beam failure recovery request signal received from the terminal 911. In the present disclosure, before attempting beam failure recovery, the TRP A 901 may first transmit information related to the beam failure to other TRP(s) via the backhaul in step S1030 in order to consider the performance of the communication links between other TRPs and the terminal. In this case, the TRP A 901 may have previously stored information on other TRPs 902 and 903 capable of communicating with the terminal 911 as described in FIG. 9. Therefore, the TRP A 901 may set a beam failure detection (BFD) indicator that notifies the beam failure with the terminal 911 to ‘1’, and transmit information on an identifier TRP A_ID of the TRP A 901 to adjacent TRPs 902 and 903 via the backhaul. In this case, the backhaul that is directly connected between the TRPs or the backhaul that is connected through base stations may be used.

FIG. 10 assumes the case where three TRPs communicate with the terminal 911 as described in FIG. 9. Therefore, in step S1030, the TRP A 901 may transmit the BFD indicator and TRP A_ID to the TRP B 902 and TRP C 903. When only the TRP B 902 or only the TRP C 903 exists as a TRP communicating with the terminal 911 in addition to the TRP A 901, the BFD indicator and TRP A_ID may be transmitted only to the corresponding TRP. If at least one other TRP not shown in FIG. 10 exists as TRP(s) communicating with the terminal 911 in addition to the TRP A 901, the BFD indicator and TRP A_ID may be transmitted to the corresponding TRP(s) in the same manner as to the TRP B 902 and TRP C 903.

As a modified example of the present disclosure, in the process of notifying the TRP B 902 and TRP C 903 of the beam failure occurring in the TRP A 901, an indicator having a different form from the BFD indicator may be transmitted. For example, the occurrence of the beam failure may be notified through a beam failure detected field (e.g. Beam Failure Detected=ENUMERATED {ON, OFF} or ENUMERATED {TRUE, FALSE}) within an RRC signaling. The TRP ID and BFD indicator may be transmitted by utilizing the backhaul between the TRPs or between base stations connected to the TRPs.

The information that the TRP A transmits to other TRPs based on the beam failure may be exemplified as in Table 3 below.

TABLE 3

| | | BFD | |
|---|---|---|---|
| | TRP ID | indicator | Delivered information |
| TRP A → | TRP ID_A | 1 | A beam failure occurred |
| TRP B | | | in the TRP A |
| TRP A → | TRP ID_A | 1 | A beam failure occurred |
| TRP C | | | in the TRP A |

After receiving information on the beam failure occurring in the TRP A 901 through the above-described process, the TRP B 902 and TRP C 903 may prepare to measure SINRs of communication links established by them with the terminal, which are affected by candidate beams that the TRP A forms with the UE panel A during the beam failure recovery process.

Meanwhile, the exemplary embodiment of FIG. 10 described above may be used in combination with at least one of the exemplary embodiment of FIG. 9 described above and/or other exemplary embodiments described below.

FIG. 11 is a signal flow diagram for a process in which an optimal beam index is selected based on indexes of beams of a TRP where a beam failure occurred according to the present disclosure.

As shown in FIG. 11, the TRP A 901, TRP B 902, TRP C 903, and terminal 911 are illustrated as described in FIGS. 9 and 10 above. A procedure of FIG. 11 described below will be described assuming the CJT environment described in FIGS. 9 and 10 above.

FIG. 11 may correspond to a procedure after a beam failure occurs between the TRP A 901 and the UE panel A and the terminal 911 requests beam failure recovery to the TRP A 901. Therefore, the TRP A 901 may need to find an optimal beam through the beam failure recovery process with the UE panel A. In the present disclosure, the TRP A 901 may perform beam failure recovery by considering adjacent TRPs during the beam failure recovery with the UE panel A.

In step S1110, the TRP A 901 may transmit indexes of candidate beams of the TRP A 901 formed to find an optimal beam with the terminal 911 to other TRPs (e.g. TRP B 902 and TRP C 903) via the backhaul connected between the TRPs or the backhaul between base stations connected to the TRPs.

Each of the TRP B 902 and TRP C 903, which receive the indexes of candidate beams of the TRP A 901 from the TRP A 901 in step S1110, may determine SINRs of a communication link established with the terminal 911 for each of the candidate beams of the TRP A 901.

The beam indexes transmitted by the TRP A 901 to the TRP B 902 and TRP C 903 in step S1110 may be transmitted through a candidateBeamRSList parameter in signaling via the backhaul directly connected between the TRPs or backhaul between base stations connected to the TRPs. As another example, the beam indexes transmitted by the TRP A 901 to the TRP B 902 and TRP C 903 in step S1110 may be transmitted using a parameter newly defined to transmit the beam indexes of the TRP A 901 according to the present disclosure. Even in this case, the beam indexes of the TRP A 901 may be transmitted via the backhaul directly connected between the TRPs or the backhaul between base stations connected to the TRPs.

In step S1120a, the TRP B 902 may receive SINRs that the terminal 911 reports to the TRP B 902 by measuring a channel between the terminal 911 and TRP B 902. Based thereon, in step S1120a, the TRP B 902 may determine the SINRs of the communication link with the UE panel B of the terminal 911. In step S1120a, the TRP B 902 may select index(es) of beam(s) of the TRP A 901 that satisfy its own SINR threshold (i.e. the minimum SINR that needs to be guaranteed for reliable communication without beam failure).

In addition, in step S1120b, the TRP C 903 may receive SINRs that the terminal 911 reports to the TRP C 903 by measuring a channel between the terminal 911 and TRP C 903. Based thereon, in step S1120b, the TRP C 903 may determine the SINRs of the communication link with the UE panel C of the terminal 911. In step S1120b, the TRP C 903 may select index(es) of beam(s) of the TRP A 901 that satisfy its own SINR threshold (i.e. the minimum SINR that needs to be guaranteed for reliable communication without beam failure).

As described above in FIG. 9, steps S1120a and S1120b may be performed simultaneously in FIG. 11 as well. As another example, steps S1120a and S1120b may be performed in the reverse order of the order illustrated in FIG. 11, that is, step S1120b followed by step S1120a. In this case, the SINRs between the TRP B 902 and the terminal 911 and the SINRs between the TRP C 903 and the terminal 911 for the beam indexes transmitted by the TRP A 901 to the TRP B 902 and TRP C 903 may be measured as shown in Table 4.

TABLE 4

| | SINRs measured | SINRs measured |
|---|---|---|
| Beam index of TRP A | for TRP B | for TRP C |
| Beam index = 1 | SINR_65 | SINR_65 |
| Beam index = 2 | SINR_70 | SINR_75 |
| Beam index = 3 | SINR_80 | SINR_60 |
| Beam index = 4 | SINR_82 | SINR_75 |
| Beam index = 5 | SINR_85 | SINR_80 |

In this case, the base station may dynamically set the SINR threshold depending on the considered situation. It may be assumed that the SINR threshold of the TRP B 902 is SINR_75 and the SINR threshold of the TRP C 903 is SINR_70.

In this case, indexes of beams of the TRP A 901 that satisfy the threshold of the TRP B 902 may be the beam index 3, beam index 4, and beam index 5. In addition, indexes of beams of the TRP A 901 that satisfy the threshold of the TRP C 903 may be the beam index 2, beam index 4, and beam index 5. This may mean that even if the TRP A 901 and the UE panel A of the terminal 911 use the corresponding beam indexes to communicate later, a beam failure may not occur for the communication links established by the TRP B 902 and TRP C 903 with the UE panel B and UE panel C, respectively.

According to the method described above, a candidate group of index(es) of beam(s) with which a beam failure may not occur for all the TRPs may be identified based on the SINR thresholds first. Then, a process of finding an optimal beam from the candidate group may be performed.

In FIG. 11, the performance for each beam index is measured by considering only SINR. However, the exemplary embodiment may also be extended to a method of measuring the performance for each beam index by using other criterion or by considering multiple criteria in combination for determining reliability of the communication links. For example, the optimal beam may be selected by considering a latency requirement of the terminal 911 or mobility of the terminal 911.

If a latency requirement of the terminal 911 is considered, a beam that supports higher performance in terms of user experienced data rate may be selected. As another example, if mobility of the terminal 911 is considered, a beam that can transmit data to the terminal 911 for a longer period of time based on the UE mobility or trajectory may be selected. As another example, a method of selecting a beam with the smallest change in the measured SINR may be also possible when considering reliability of the channel.

Meanwhile, the exemplary embodiment of FIG. 11 described above may be used in combination with at least one of the exemplary embodiments of FIGS. 9 and 10 described above and/or other exemplary embodiments described below.

FIG. 12 is a signal flow diagram for a process in which information on index(es) of beam(s) satisfying an SINR threshold is delivered according to the present disclosure.

As shown in FIG. 12, the TRP A 901, TRP B 902, TRP C 903, and terminal 911 are illustrated as described in FIGS. 9 to 11 above. A procedure of FIG. 12 described below will be described assuming the CJT environment described in FIGS. 9 to 11 above.

FIG. 12 illustrates a state in which each of the TRP B 902 and TRP C 903 in FIG. 11 described above selects index(es) of beam(s) of the TRP A 901 that have an SINR greater than or equal to the SINR threshold. Therefore, the TRP B 902 and TRP C 903 may each obtain index(es) of beam(s) of the TRP A 901 that have an SINR greater than or equal to the SINR threshold.

In step S1210, the TRB B 902 may transmit, to the TRP A 901, information on index(es) of beam(s) of the TRP A 901 that can ensure communication through a communication link with the terminal 911 (e.g. communication link established between the TRP B 902 and the UE panel B of the terminal 911).

In step S1220, the TRB C 903 may transmit, to the TRP A 901, information on index(es) of beam(s) of the TRP A 901 that can ensure communication through a communication link with the terminal 911 (e.g. communication link established between the TRP C 903 and the UE panel C of the terminal 911).

Using Table 4 and the thresholds of the TRP B 902 and TRP C 903 at the bottom of Table 4, index(es) of beam(s) of the TRP A 901 satisfying the threshold of the TRP B 902 may be the beam index 3, beam index 4, and beam index 5, and index(es) of beam(s) of the TRP A 901 satisfying the threshold of the TRP C 903 may be the beam index 2, beam index 4, and beam index 5.

Accordingly, in step S1210, the TRB B 902 may transmit the beam index 3, beam index 4, and beam index 5 to the TRP A 901 via the backhaul. In addition, in step S1220, the TRB C 903 may transmit the beam index 2, beam index 4, and beam index 5 to the TRP A 901 via the backhaul.

In the description of FIG. 12, the case where the beam indexes are transmitted in the order of steps S1210 and S1220 has been described as an example. However, depending on an implementation method and a delay time for obtaining the SINRs in each TRP, steps S1210 and S1220 may be performed in the reverse order. As another example, steps S1210 and S1220 may be performed simultaneously.

The beam indexes received by the TRP A 901 from the TRP B 902 and TRP C 903 as described in FIG. 12 may be exemplified as in Table 5 below.

TABLE 5

| | Delivered information |
|---|---|
| TRP B → TRP A | Beam indexes = 3, 4, 5 |
| TRP C → TRP A | Beam indexes = 2, 4, 5 |

Meanwhile, the exemplary embodiment of FIG. 12 described above may be used in combination with at least one of the exemplary embodiments of FIG. 9 to FIG. 11 described above and/or other exemplary embodiments described below.

FIG. 13 is a signal flow diagram for a process in which a TRP where a beam failure occurred selects a beam for beam recovery according to the present disclosure.

As shown in FIG. 13, the TRP A 901, TRP B 902, TRP C 903, and terminal 911 are illustrated as described in FIGS. 9 to 12 above. A procedure of FIG. 13 described below will be described assuming the CJT environment described in FIGS. 9 to 12 above.

FIG. 13 shows that when selecting a beam to be used for communication in the TRP A 901 where the beam failure occurred, an optimal beam index may be selected by considering the performance of the communication links between the terminal 901 and other TRPs 902 and 903 and the performance of the communication link between the TRP A 901 and the terminal 911.

To this end, the TRP A 901 may obtain SINRs with the UE panel A of the terminal 911 in advance for the respective candidate beams. The SINRs received by the TRP A 901 from the terminal 911 for the respective candidate beam indexes may be exemplified in Table 6 below.

TABLE 6

| beamCandidateSet | SINRs of TRP A |
|---|---|
| Beam index = 1 | SINR_95 |
| Beam index = 2 | SINR_80 |
| Beam index = 3 | SINR_100 |
| Beam index = 4 | SINR_70 |
| Beam index = 5 | SINR_75 |

In addition, the TRP A 901 may have received in advance the index(es) of beam(s) that satisfy the SINR thresholds from the TRP B 902 and TRP C 903 through the procedure of FIG. 12 described above. As described above in FIG. 12, the TRB B 902 may have transmitted the beam index 3, beam index 4, and beam index 5 to the TRP A 901 via the backhaul, and the TRB C 903 may have transmitted the beam index 2, beam index 4, and beam index 5 to the TRP A 901 via the backhaul.

The TRP A 901 may determine the index(es) of beam(s) received from the TRP B 902 and TRP C 903 and index(es) of beam(s) based on the measured SINRs between the TRP A 901 and terminal 911. When there are a total of 5 beams from the beam index 1 to beam index 5, beam indexes selectable based on the index(es) of beam(s) received from the TRP B 902 and TRP C 903 and the SINRs between the TRP A 901 and terminal 911 may be as shown in Table 7 below.

TABLE 7

| beamCandidateSet | SINRs of TRP A | TRP B | TRP C |
|---|---|---|---|
| Beam index = 4 | SINR_70 | satisfied | satisfied |
| Beam index = 5 | SINR_75 | satisfied | satisfied |

In step S1310, the TRP A 901 may select an index of a beam to be finally used with the UE panel A of the terminal 911 based on Table 7. Based on Table 7 above, the TRP A 901 may select a beam corresponding to the beam index 5 as an optimal beam. In other words, the TRP A 901 may select an index of a beam with the largest SINR among the beams of the TRP A 901 in Table 7.

Meanwhile, the exemplary embodiment of FIG. 13 described above may be used in combination with at least one of the exemplary embodiments of FIGS. 9 to 12 described above and/or exemplary embodiments described below.

According to the exemplary embodiments of FIGS. 9 to 13 described above, while the TRP A 901 is performing the beam failure recovery process with the UE panel A, the TRP A may receive, from the adjacent TRPs (i.e. TRP B 902 and TRP C 903), index(es) of beam(s) of the TRP A 901 that guarantees their communication performances to a certain level or higher. In this case, information on the index(es) of beam(s) of the TRP A 901 may be received via the backhaul between the TRPs or the backhaul between base station connected to the TRPs. Then, the TRP A 901 may select the best beam among the beams that can be configured with the terminal 911.

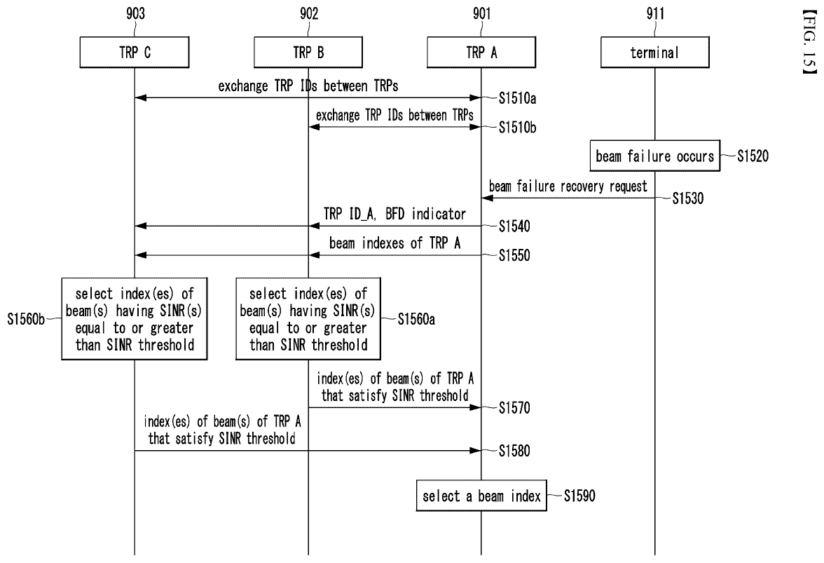

FIG. 14 is a sequence chart illustrating a beam failure recovery process in the MTRP CJT environment according to an exemplary embodiment of the present disclosure.

As shown in FIG. 14, in step 1410, when a beam failure recovery request is received from the terminal 911 based on occurrence of a beam failure, the TRP A 901 may transmit information on the beam failure to other TRPs communicating with the terminal 911 (i.e. TRP B 902 and TRP C 903). In this case, the TRP A 901 may transmit its own TRP ID together to inform the TRP B 902 and TRP C 903 of the TRP where the beam failure occurred. In addition, the TRP A 901 may inform the TRP B 902 and TRP C 903 of indexes of candidate beams formed between the TRP A 901 and the terminal 911.

In step 1420, each of the TRP B 902 and TRP C 903 may receive the SINRs corresponding to the indexes of candidate beams, based on the information on the beam failure and the indexes of candidate beams formed by the TRP A 901 and the terminal 911 received in step S1410. Then, each of the TRP B 902 and TRP C 903 may transmit index(es) of beam(s) that have SINRs greater than or equal to the threshold among the SINRs received from the terminal 911 to the TRP A 901.

In step 1430, the TRP A 901 may receive the SINRs from the terminal 911 for the candidate beams formed between the TRP A 901 and the terminal 911. The TRP A 901 may select an index of a beam with the highest SINR among candidate beams that can be commonly used by the TRPs based on the index(es) of beam(s) respectively received from the TRP B 902 and TRP C 903 and the SINRs received from the terminal 911 in step 1420.

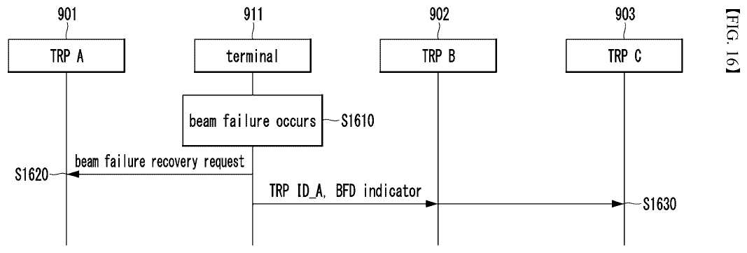

FIG. 15 is a signal flow diagram according to an exemplary embodiment in which all the procedures of FIGS. 9 to 13 are performed as being combined according to the present disclosure.

Therefore, FIG. 15 illustrates the TRP A 901, TRP B 902, TRP C 903, and terminal 911 as described above in FIGS. 9 to 13, and may correspond to the case assuming the CJT environment. Since the CJT environment is assumed, each of the TRPs 901 to 903 may transmit/receive data between the TRPs 901 to 903 via the backhaul between the TRPs and/or backhaul with at least one base station.

Steps S1510a and S1510b illustrated in FIG. 15 may be the procedure for exchanging TRP IDs between the TRPs 901 to 903 as described above in FIG. 9. Step S1520 may be the step for detecting a beam failure in the terminal 911, i.e., step S1010 illustrated in FIG. 10. Steps S1530 and S1540 may each correspond to step S1020 in which the terminal 911 transmits a beam failure recovery request to the TRP A 901, and step S1030 in which the TRP A 901 transmits its TRP ID and a beam failure detection (BFD) indicator to adjacent TRPs 902 and 903, as described in FIG. 10.

Step S1550 may correspond to step S1110 illustrated in FIG. 11 in which the TRP A 901 transmits indexes of candidate beams configured for beam failure recovery with the terminal 911 to the adjacent TRPs 902 and 903, and steps S1560a and S1560b may correspond to steps S1120a and S1120b illustrated in FIG. 11 in which the TRP B 902 and TRP C 903 each select index(es) of beam(s) whose SINRs are greater than or equal to the threshold.

Steps S1570 and S1580 may correspond to steps S1210 and S1220 illustrated in FIG. 12 in which the TRP B 902 and TRP C 903 each transmit, to the TRP A 901, index(es) of beam(s) whose SINRs are greater than or equal to the threshold.

Step S1590 may correspond to the step in which the TRP A 901 selects the optimal beam for beam failure recovery with the terminal 911 in FIG. 13.

In the exemplary embodiment of FIG. 15, the beam failure recovery procedure in the CJT environment is described with one signal flow assuming that all the procedures according to the exemplary embodiments of FIGS. 9 to 13 are performed. However, the exemplary embodiments of FIGS. 9 to 13 may proceed differently from the order illustrated in FIG. 15, and some of the exemplary embodiments of FIGS. 9 to 13 may be implemented so as not to be performed.

### (2) Beam Failure Recovery Procedure in MTRP NCJT Environment

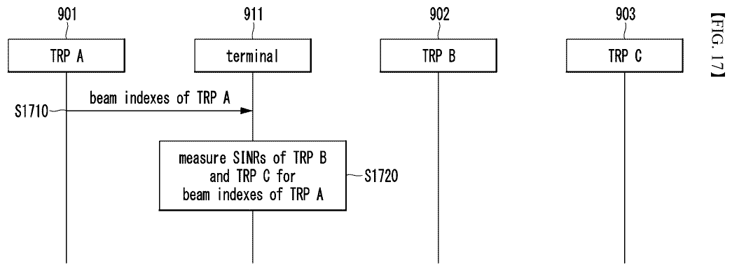

The present disclosure described below will describe a beam failure recovery procedure in the MTRP NCJT environment. In the MTRP NCJT environment, it may be assumed that three TRPs (e.g. TRP A, TRP B, and TRP C) support a single terminal with multiple panels, similarly to the MTRP CJT environment described above. In addition, a situation will be described where a beam failure occurs on a communication link between the TRP A and the UE panel A of the terminal, and beam failure recovery is performed. In addition, FIGS. 16 to 22 described below assume the NCJT environment.

Since the terminal communicates with multiple TRPs in the MTRP environment, there may be a situation in which a beam failure occurs only for a specific TRP, not all TRPs. In this case, if the terminal independently performs a beam failure recovery procedure with the TRP where the beam failure occurred, since the terminal simultaneously communicates with other TRPs where the beam failure did not occur, performance degradation may occur on communication links for the other TRPs that have been established previously.

To prevent this, when performing beam failure recovery between the TRP and the terminal, the communication performance between other TRPs and the terminal needs to be considered. In the present disclosure, a process in which information indicating that a beam failure occurred is transmitted to other TRPs when the beam failure occurred in a specific TRP and beam failure recovery is performed considering the communication performance of the other TRPs will be described.

Since synchronization between TRPs is impossible in the MTRP NCJT environment, the information transmitted and received via the backhaul between the TRPs or base stations connected to the TRPs in FIGS. 9 to 13 may be transmitted and received via the terminal in procedures of FIGS. 16 to 22 described below by utilizing the terminal as an intermediate forwarder instead of the backhaul. Specifically, in the NCJT environment, a procedure is provided for a TRP to transmit the TRP ID, BFD indicator, and information on index(es) of beam(s) to other TRPs via the terminal. These information has been described as being transmitted and received via the backhaul between the TRPs or base stations connected to the TRPs in the CJT environment.

FIG. 16 described below assumes that a beam failure occurs on the communication link established between the TRP A, among the TRP A, TRP B, and TRP C that are communicating with the terminal, and the UE panel A of the terminal. In this case, FIG. 16 may correspond to a process in which the terminal notifies the TRP B and TRP C of information of a TRP ID of the TRP A and information on the beam failure of the TRP A.

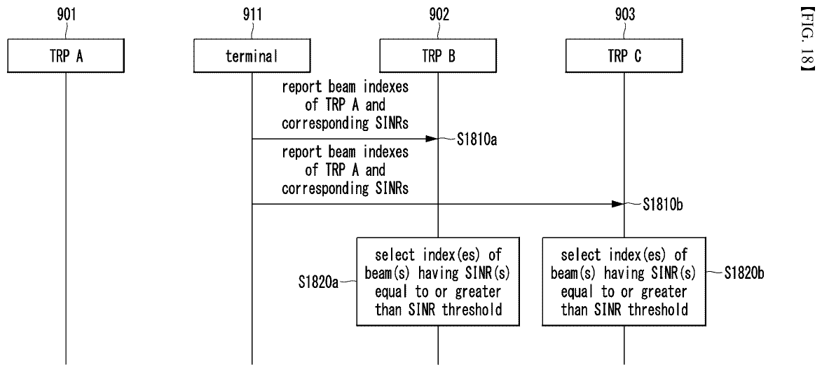

FIG. 17 may correspond to a procedure for observing the effect of candidate beams formed by the TRP A for the UE panel A of the terminal during the beam failure recovery process on the communication links established by the TRP B and TRP C. Specifically, FIG. 17 may correspond to a process in which the terminal measures SINRs of the communication links established with the TRP B and TRP C for each of the candidate beams of the TRP A, and report them to each TRP.

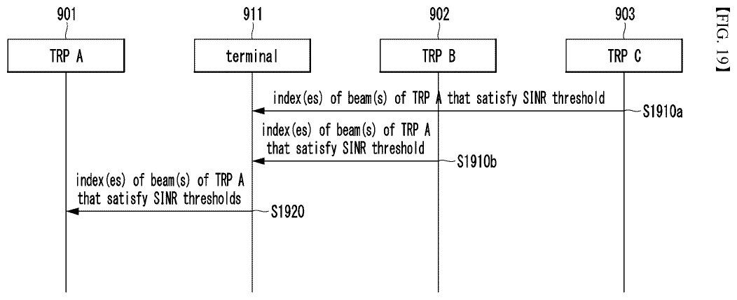

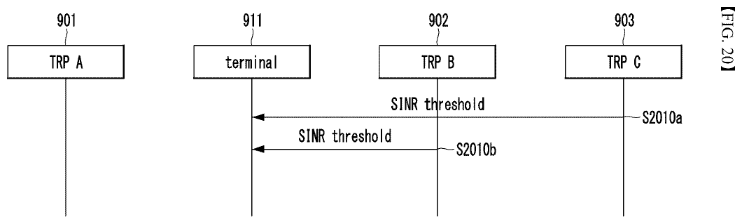

FIGS. 18 and 19 may correspond to cases in which entities determining index(es) of beam(s) of the TRP A satisfying the SINR thresholds are the TRP B and TRP C. In particular, FIG. 18 may correspond to a procedure in which the terminal additionally transmits the index(es) of beam(s) of the TRP A when reporting the SINRs to the TRP B and TRP C. FIG. 19 may correspond a procedure in which the TRP B and TRP C select index(es) of beam(s) of the TRP A satisfying their respective SINR thresholds, and then transmit the selected beam index(es) to the TRP A via the terminal.

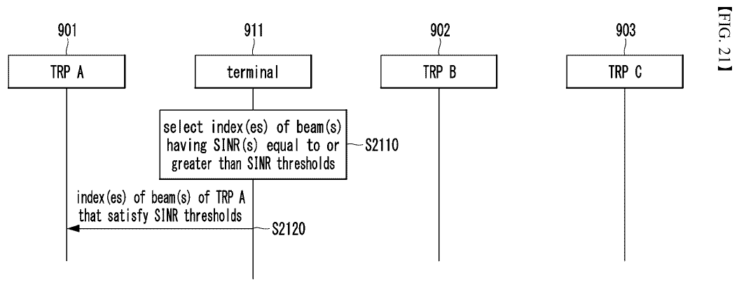

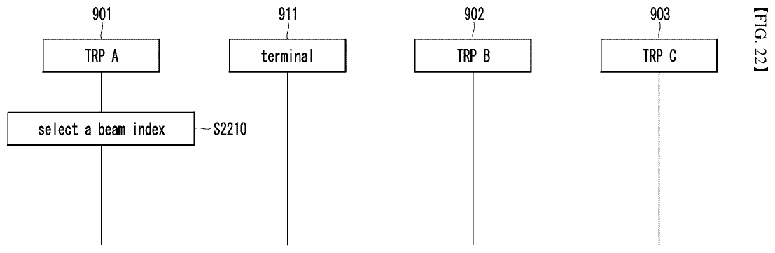

FIGS. 20 and 21 may correspond to cases in which an entity determining index(es) of beam(s) of the TRP A satisfying the SINR thresholds is the terminal. In particular, FIG. 20 may correspond to a procedure in which the TRP B and TRP C transmit their SINR thresholds to the terminal when they receive beam failure occurrence information on the communication link between the TRP A and the terminal from the terminal. FIG. 21 may correspond to a procedure in which the terminal transmits index(es) of beam(s) of the TRP A satisfying the SINR threshold to the TRP A based on the indexes of candidate beams of the TRP A and the SINRs of the TRP B and TRP C corresponding to the indexes of candidate beams of the TRP A.

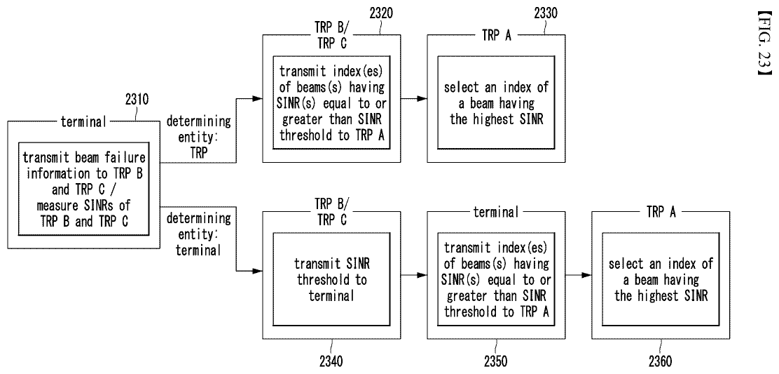

FIG. 22 may correspond to a process in which the TRP A selects a beam with the highest SINR among beam(s) of the TRP A satisfying the thresholds obtained through the procedures of FIGS. 18 and 19 or FIGS. 20 and 21.

In summary, FIGS. 16 and 17 may correspond to operations when a beam failure occurs on the communication link established between the TRP A and the UE panel A. In this case, in order to select a beam among candidate beams formed by the TRP A for beam failure recovery, which guarantees a certain level of performance or higher for the communication link established between the TRB B and the UE panel B and the communication link established between the TRP C and the UE panel C, the TRP A may transmit indexes of newly formed candidate beams to the terminal.

If an entity that determines index(es) of beam(s) of the TRP A that satisfy the SINR thresholds of communication links established between other TRPs and the terminal is another TRP, the terminal may report indexes of candidate beams of the TRP A and SINRs of the TRP B and TRP C for each of the indexes of candidate beams of the TRP A to the TRP B and TRP C through the processes of FIG. 18 and FIG. 19. Then, each of the TRP B and TRP C may determine beam(s) of the TRP A that satisfy its own SINR threshold and transmit index(es) of the determined beam(s) to the TRP A via the terminal.

On the other hand, if an entity responsible for the determination is the terminal, the terminal may receive the SINR thresholds from the TRP B and TRP C through the processes of FIG. 20 and FIG. 21, and the terminal may determine an appropriate beam of the TRP A and transmit an index of the determined beam to the TRP A.

Finally, FIG. 22 may correspond to a process for the TRP A to select an optimal beam from among beams of the TRP A that satisfy the SINR threshold of the TRP B and the SINR threshold of the TRP C, which are informed through the procedures of FIGS. 18 and 19 or FIGS. 20 and 21, considering the performance of the communication link between the TRP A and the terminal.

Hereinafter, more detailed operations will be described with reference to each drawing.

FIG. 16 is a signal flow diagram for beam failure recovery according to the present disclosure in the MTRP NCJT environment.

As shown in FIG. 16, the TRP A 901, TRP B 902, and TRP C 903 are illustrated as described in FIGS. 9 to 15. However, unlike the cases described in FIGS. 9 to 15, FIG. 16 may assume that the TRP A 901, TRP B 902, and TRP C 903 cannot transmit and receive data via a backhaul connected either directly or through base stations.

The TRPs 901 to 903 shown in FIG. 16 may be TRPs capable of communicating with the terminal 911. In addition, it may be assumed that the terminal has three or more different panels so that it can communicate with the different TRPs 901 to 903. For example, it may be assumed that the terminal 911 communicates with the TRP A 901 using a panel A (not shown), communicates with the TRP B 902 using a panel B (not shown), and communicates with the TRP C 903 using a panel C (not shown).

As described above, when the terminal 911 is communicating with the TRP A 901, TRP B 902, and TRP C 903, a beam failure may occur on a communication link with a specific TRP, for example, the TRP A 901.

In step S1610, the terminal 911 may recognize that a beam failure occurs on the communication link with the TRP A 901. For example, a beam failure may occurs when the terminal 911 declares the beam failure if the number of beam failure instances (BFI) exceeds the maximum allowable number for a communication link established between the terminal 911 and a specific TRP. Therefore, the terminal 911 may be in a situation where a beam failure recovery procedure needs to be performed. In other words, occurrence of the beam failure may correspond to a situation where BFI_COUNTER>=beamFailureInstanceMaxCount.

Here, BFI indicates a situation where a block error rate (BLER) is equal to or greater than a certain threshold, and a count value may be increases by 1 for each BFI. If the count value does not increase within a certain time after the count value increases by 1, BFI_COUNTER may be reset to zero (0). When BFI_COUNTER is reset as described above, it may be interpreted that no more BFIs have occurred.

If a beam failure occurs as above, in step S1620, the terminal 911 may transmit beam failure recovery request information to the TRP A 901 through BeamFailureRecoveryConfig of RRC signaling including information such as rach-ConfigBFR, rsrp-ThresholdSSB and/or candidateBeamRSList.

In step S1630, the terminal 911 may transmit a TRP ID of the TRP A 901 and information on the beam failure of the TRP A to the TRP B 902 and TRP C 903 in order to consider the performance of the communication links between other TRPs 902 and 903 and the terminal during a beam failure recovery process between the TRP A 901 and the terminal 911. In this case, as described above, the beam failure may have occurred in the communication link between the UE panel A of the terminal 911 and the TRP A 901. In this case, the terminal 911 according to the present disclosure may set a BFD indicator to ‘1’ to indicate the beam failure, and transmit beam failure information to the TRP B 902 that established the communication link with the UE panel B of the terminal 911 and to the TRP C 903 that established the communication link with the UE panel C of the terminal 911.

In the process in which the terminal 911 notifies the TRP B 902 and TRP C 903 of the beam failure occurring between the TRP A 901 and the UE panel A, an indicator having a different form from the BFD indicator may be transmitted. For example, the occurrence of the beam failure may be notified through a beam failure detected field (e.g. Beam Failure Detected=ENUMERATED {ON, OFF} or ENUMERATED {TRUE, FALSE}) within an RRC signaling.

In addition, if the TRP B 902 and TRP C 903 are connected to the same base station as the base station to which the TRP A 901 is connected, the terminal 911 may transmit the BFD indicator and TRP ID of the TRP A to the TRP B 902 and TRP C 903 through uplink control information (UCI), measurement report, UE assistance information, or RRC signaling newly defined to inform the beam failure and the TRP ID of the TRP where the beam failure occurred.

As another example, if the TRP B 902 and TRP C 903 are connected to base station(s) different from a base station connected to the TRP A 901, the terminal 911 may transmit the TRP ID of the TRP A and the BFD indicator to the TRP B 902 and TRP C 903 through a Msg1 or MsgA of a RACH access procedure (hereinafter referred to as ‘RACH procedure’). As another example, the BFD indicator and TRP ID of the TRP A may be transmitted through SN measurement report or SN UE assistance information of SRB 3, or an SRB3 signaling newly defined to inform the beam failure and the TRP ID of the TRP A where the beam failure occurred according to the present disclosure.

The information transmitted from the terminal 911 to the TRPs may be exemplified as shown in Table 8.

TABLE 8

| | TRP ID | BFD indicator | Beam failure information |
|---|---|---|---|
| UE panel B | TRP ID_A | 1 | A beam failure occurred |
| → TRP B | | | in TRP A |
| UE panel C | TRP ID_A | 1 | A beam failure occurred |
| → TRP C | | | in TRP B |

Meanwhile, the exemplary embodiment of FIG. 16 described above may be used in combination with at least one of other exemplary embodiments described below.

Then, upon receiving information from the TRP A indicating that the beam failure occurred, each of the TRP B 902 and TRP C 903 may prepare to measure SINRs of their currently established communication links. These links are affected by candidate beams formed by TRP A for the UE panel A during the beam failure recovery process.

FIG. 17 is a signal flow diagram of beam failure recovery according to the present disclosure in the MTRP NCJT environment.

As shown in FIG. 17, the TRP A 901, TRP B 902, and TRP C 903 are illustrated as described in FIGS. 9 to 16. However, unlike the cases described in FIGS. 9 to 16, FIG. 17 assumes that the TRP A 901, TRP B 902, and TRP C 903 cannot transmit and receive data via a backhaul connected either directly or through base stations.

FIG. 17 may correspond to a procedure in which the TRP A 901 where a beam failure occurred transmits indexes of candidate beams formed in a process of finding an optimal beam through the beam failure recovery process with the terminal 911 to the terminal 911, and the terminal 911 observes changes in SINR performances of other TRPs for the indexes of candidate beams.

First, the TRP A 901 where the beam failure occurred may have received a beam failure recovery request based on FIG. 16 described above. Therefore, the TRP A 901 may perform step S1710 in response to the beam failure recovery request. In this case, the TRP A 901 may further perform a procedure for checking whether it is connected to other TRPs 902 and 903 communicating with the terminal 911 via a backhaul. For example, if the TRP A 901 is connected to other TRPs 902 and 903 communicating with the terminal 911 via a backhaul, it may correspond to the CJT environment described above through FIGS. 9 to 15. The procedure of FIG. 17 may correspond to a case where the TRP A 901 is not connected to other TRPs 902 and 903 communicating with the terminal 911 via a backhaul.

In step S1710, the TRP A 901 may transmit the indexes of candidate beams of the TRP A 901 to the terminal 911. In other words, step S1710 may correspond to a step in which the terminal 911 receives the indexes of candidate beams from the TRP A 901 when the TRP A 901 and the UE panel A of the terminal 911 perform the beam failure recovery procedure.

In step S1720, the terminal 911 may measure SINRs of the communication link between the TRP B 902 and the UE panel B for the respective candidate beams. In this case, the SINRs of the communication link between the TRP B 902 and the UE panel B may be SINRs measured based on the candidate beams of the TRP A 901.

In addition, in step S1720, the terminal 911 may measure SINRs of the communication link between the TRP C 903 and the UE panel C for the candidate beams. In this case, the SINRs of the communication link between the TRP C 903 and UE panel C may be SINRs measured based on the candidate beams of the TRP A 901.

Since the example of FIG. 17 corresponds to an operation under the MTRP NCJT environment, a backhaul cannot be formed between the TRPs or between base stations connected to the TRPs, and information cannot be directly exchanged between the TRPs. Therefore, the TRP A 901 may provide information on indexes of all candidate beams of itself to the terminal 911 in order to receive index(es) of specific beam(s) that satisfy a certain performance or higher for the communication links established by the TRP B 902 and TRP C 903 with the terminal 911 (step S1710).

In addition, the terminal 911 may measure SINRs of the communication links established by the TRP B 902 and TRP C 903 for all the candidate beams of the TRP A 901 in order to determine beam(s) that satisfy the SINR thresholds of other TRPs 902 and 903.

The entity(ies) of determining an optimal beam between the TRP A 901 and the UE panel A of terminal 911 based on the candidate beams of the TRP A 901 and information on the SINRs of the TRP B 902 and TRP C 903 for the candidate beams of the TRP A 901 may be the terminal 911 or other TRPs 902 and/or 903.

If the entity for the determination is the terminal 911, the terminal 911 may select an optimal beam through a procedure of FIG. 21 based on the SINR thresholds obtained through a procedure of FIG. 20, after performing the procedures of FIG. 16 and FIG. 17.

Meanwhile, in FIG. 17, only the performance for each beam considering only the SINR has been described. However, the exemplary embodiments may be extended to a method of considering the performance for each beam by using another criterion for determining a reliable communication link or by considering multiple criteria in combination. For example, the optimal beam may be selected by considering a latency requirement of the terminal 911 or mobility of the terminal 911. When considering a latency requirement of the terminal 911, a beam that supports higher performance in terms of user experienced data rate may be selected. As another example, when considering the mobility of the terminal 911, a beam that can transmit data to the terminal 911 for a longer period of time may be selected based on UE mobility or trajectory of the terminal 911. As another example, when considering reliability of the channel, it is also possible to select a beam with the smallest change in the measured SINR.

The TRP A 901 may transmit information on indexes of candidate beams of itself and information instructing index(es) of beam(s) (i.e. beam index report instruction) to the terminal 911 through a UEInformationRequest of RRC signaling. The beam index report instruction may instruct to report index(es) of beam(s) that satisfy threshold conditions in adjacent or other TRP(s) communicating with the terminal 911, such as the TRP B 902 and TRP C 903. The conditions in adjacent or other TRP(s) communicating with the terminal 911 may exist as various conditions as described above. In the present disclosure, for convenience of description, only SINRs will be used for description. Therefore, the conditions in adjacent or other TRPs communicating with the terminal 911 may be a condition of satisfying the SINR threshold(s) of other TRP(s).

The terminal 911 that receives the information on indexes of candidate beams and the beam index report instruction may forward information on index(es) of beam(s) determined through the procedure of FIG. 19 or FIG. 21 described below to the TRP A 901.

In addition, the TRP A 901 may transmit, to the terminal 911, information instructing to report measured SINR(s) of the TRP B 902 and TRP C 903 and information on index(es) of beams(s) that satisfy the SINR thresholds, by using an RRC reconfiguration message or an RRC signaling newly defined to transmit such information related to the beam index report instruction.

The information obtained by the terminal 911 in steps S1710 and S1720 may be exemplified as shown in Table 9 below.

TABLE 9

| Beam indexes of TRP A | SINRs of TRP B | SINRs of TRP C |
|---|---|---|
| Beam index = 1 | SINR_65 | SINR_65 |
| Beam index = 2 | SINR_70 | SINR_75 |
| Beam index = 3 | SINR_80 | SINR_60 |
| Beam index = 4 | SINR_82 | SINR_75 |
| Beam index = 5 | SINR_85 | SINR_80 |

Meanwhile, the exemplary embodiment of FIG. 17 described above may be used in combination with at least one of the exemplary embodiment of FIG. 16 described above and/or other exemplary embodiments described below.

FIG. 18 is a flow chart for a process in which an adjacent TRP of a TRP where a beam failure occurred selects an optimal beam for beam failure recovery according to the present disclosure in the MTRP NCJT environment.

As shown in FIG. 18, the TRP A 901, TRP B 902, and TRP C 903 are illustrated as described in FIGS. 9 to 17. However, like the cases described in FIGS. 16 and 17, FIG. 18 assumes that the TRP A 901, TRP B 902, and TRP C 903 cannot transmit and receive data via a backhaul connected either directly or through base stations.

FIG. 18 may correspond to a case where, when beam failure recovery is performed on the communication link established by the TRP A 901 and the UE panel A of the terminal 911, entities that determine the performance of communication links established by the TRP B 902 and TRP C 903 and the UE panel B and UE panel C of the terminal 911 are the TRP B 902 and TRP C 903. To this end, the terminal 911 may need to report SINRs measured for each of the TRPs 902 and 903 for the respective candidate beams with the TRP A 901 to each of the TRPs 902 and 903 as described in FIG. 17.

In step S1810a, the terminal 911 may report SINRs between the UE panel B of the terminal 911 and the TRP B 902 for the respective candidate beams with the TRP A 901 to the TRP B 902.

In step S1810b, the terminal 911 may report SINRs between the UE panel C of the terminal 911 and the TRP C 903 for the respective candidate beams with the TRP A 901 to the TRP C 903.

The reason why the terminal 911 reports the SINRs to the TRP B 902 and TRP C 903 is that the entities of determining the performance of the communication links are the TRP B 902 and TRP C 903. Therefore, considering the NCJT environment, the terminal 911 may transmit information on indexes of beams to the TRP B 902 and TRP C 903. These information has been described as information exchanged via the backhaul between TRPs or between base stations connected to the TRPs in the CJT environment. The information reported by the terminal 911 to the TRP B 902 and TRP C 903 as described above may be exemplified as in Table 10 below.

TABLE 10

| | Delivered information |
|---|---|
| UE panel B → TRP B | Beam index = 1, SINR_65 |
| | Beam index = 2, SINR_70 |
| | Beam index = 3, SINR_80 |
| | Beam index = 4, SINR_82 |
| | Beam index = 5, SINR_85 |
| UE panel C → TRP C | Beam index = 1, SINR_65 |
| | Beam index = 2, SINR_75 |
| | Beam index = 3, SINR_60 |
| | Beam index = 4, SINR_75 |
| | Beam index = 5, SINR_80 |

When comparing FIG. 18 according to the present disclosure with the case described in FIG. 11 which corresponds to the CJT environment, the following interpretation may be given.

In the case of FIG. 11, the TRP A 901 may transmit information on indexes of candidate beams of itself to the TRP B 902 and TRP C 902 via the backhaul between the TRPs or between base stations connected to the TRPs. However, in the NCJT environment, the TRP A 901 cannot directly transmit information on indexes of candidate beams of itself to other TRPs 902 and 903. Therefore, in the present disclosure, the terminal 911 may be configured as an intermediate forwarder, and the terminal 911 may forward such information to the TRP B 902 and TRP C 903.

Meanwhile, as exemplified in Table 10, the terminal 911 may forward information on indexes of candidate beams of the TRP A 901 to the TRP B 902 and TRP C 903 together in the process of reporting SINRs of the TRP B 902 and TRP C 903 measured by the terminal 911. In addition, the terminal 911 may transmit, to each of the TRPs 902 and 903, information instructing to report index(es) of beam(s) of the TRP A 901 that satisfy the SINR threshold of the terminal 911.

The terminal 911 may transmit information on SINRs of the TRP B 902 and TRP C 903 for the respective candidate beams of the TRP A 902. In addition, the terminal 901 may transmit, to the TRP B 902 and TRP C 903, information instructing to report index(es) of beam(s) of the TRP A 901 that satisfy their SINR thresholds. In this case, if the TRP B 902 and TRP C 903 are connected to the same base station as the base station to which the TRP A 901 is connected, the report instruction information regarding index(es) of beam(s) of the TRP A 901 may be transmitted through UCI, UE assistance information, or new RRC signaling defined to transmit such information according to the present disclosure. As another example, if the TRP B 902 and TRP C 903 are connected to different base station(s) from the base station connected to the TRP A 901, the report instruction information regarding index(es) of beam(s) of the TRP A 901 may be transmitted through a Msg1 or MsgA of a RACH procedure. As another example, the report instruction information regarding index(es) of beam(s) of the TRP A 901 may be transmitted through SN UE assistance information of SRB3 or SRB3 signaling newly defined to transmit such information described above according to the present disclosure.

In step S1820a, the TRP B 902 may select index(es) of beam(s) of the TRP A 902 that guarantee a certain level or higher performance of the communication link established between the TRP B 902 and UE panel B among the indexes of candidate beams newly formed by the TRP A 901 for the UE panel A by utilizing its own SINRs received together with the indexes of candidate beams of the TRP A 901 which are received from the terminal 911.

In step S1820b, the TRP C 903 may select index(es) of beam(s) of the TRP A 902 that guarantee a certain level or higher performance of the communication link established between the TRP C 903 and UE panel C among the indexes of candidate beams newly formed by the TRP A 901 for the UE panel A by utilizing its own SINRs received together with the indexes of candidate beams of the TRP A 901 which are received from the terminal 911.

Meanwhile, in FIG. 18, only the performance for each beam considering only the SINR has been described. However, the exemplary embodiments may be extended to a method of considering the performance for each beam by using another criterion for determining a reliable communication link or by considering multiple criteria in combination. For example, the optimal beam may be selected by considering a latency requirement of the terminal 911 or mobility of the terminal 911. When considering a latency requirement of the terminal 911, a beam that supports higher performance in terms of user experienced data rate may be selected. As another example, when considering the mobility of the terminal 911, a beam that can transmit data to the terminal 911 for a longer period of time may be selected based on UE mobility or trajectory of the terminal 911. As another example, when considering reliability of the channel, it is also possible to select a beam with the smallest change in the measured SINR.

Meanwhile, the exemplary embodiment of FIG. 18 described above may be used in combination with at least one of the exemplary embodiments of FIG. 16 and FIG. 17 described above and/or other exemplary embodiments described below.

FIG. 19 is a signal flow diagram for a process in which a TRP where a beam failure occurred selects an optimal beam for beam failure recovery based on information received from adjacent TRPs via the terminal according to the present disclosure in the MTRP NCJT environment.

As shown in FIG. 19, the TRP A 901, TRP B 902, and TRP C 903 are illustrated as described in FIGS. 9 to 19. However, like the cases described in FIGS. 16 to 18, FIG. 19 assumes that the TRP A 901, TRP B 902, and TRP C 903 cannot transmit and receive data via a backhaul connected either directly or through base stations.

The signal flow of FIG. 19 may correspond to a signal flow for a case where entities that determine the performance of the communication link between the TRP B 902 and UE panel B of the terminal 911 and the performance of the communication link between the TRP C 903 and UE panel C of the terminal 911 when performing beam failure recovery for the communication link formed between the TRP A 901 and UE panel A of the terminal 911 are the TRP B 902 and TRP C 903, respectively.

Each of the TRP B 902 and TRP C 903 of FIG. 19 may determine index(es) of beam(s) of the TRP A 901 that satisfy its threshold condition based on the information received from the terminal 911 through the procedure of FIG. 18 described above. Each of the TRP B 902 and TRP C 903 may generate a message including index(es) of beam(s) that satisfy the threshold condition based on such determination.

In step S1910a, the TRP B 902 may transmit, to the terminal 911, the message generated based on the above description, that is, the message including index(es) of beam(s) of the TRP A 901 that satisfy the threshold condition.

In step S1910b, the TRP C 903 may transmit, to the terminal 911, the message generated based on the above description, that is, the message including index(es) of beam(s) of the TRP A 901 that satisfy the threshold condition.

This will be described in further detail by assuming the case of Table 4 described in FIG. 12.

In the case of Table 4, among the indexes of candidate beams of the TRP A, index(es) of beam(s) of the TRP A 901 that satisfy the threshold condition of the TRP B 902 may be the beam index 3, beam index 4, and beam index 5. Therefore, the message transmitted to the terminal in step S1910a may include information on the beam index 3, beam index 4, and beam index 5.

In the case of Table 4, among the indexes of candidate beams of the TRP A, index(es) of beam(s) of the TRP A 901 that satisfy the threshold condition of the TRP C 903 may be the beam index 2, beam index 4, and beam index 5. Therefore, the message transmitted to the terminal in step S1910b may include information on the beam index 2, beam index 4, and beam index 5.

The terminal 911 may receive the index(es) of beam(s) of the TRP A 901 from each of the TRP B 902 and TRP C 903 in steps S1910a and S1910b. Therefore, the terminal 911 may generate a message including the indexes of beams of the TRP A 901 received from each of the TRP B 902 and TRP C 903. In step S1920, the terminal 911 may transmit, to the TRP A 901, the generated message including the indexes of beams of the TRP A 901 that satisfy the SINR threshold in each of the TRPs 902 and 903.

Thereafter, the TRP A 901 may select beam(s) that can guarantee a certain level or higher communication performance of the communication link established by the TRP B 902 and the UE panel B of terminal 911 and the communication link established by the TRP C 903 and the UE panel C of terminal 911 among the candidate beams formed by itself with the UE panel A of the terminal 911 based on the indexes of beams that satisfy the SINR thresholds in the TRP B 902 and TRP C 903, which were forwarded by the terminal 911. This means that even if the TRP A 901 selects either the beam index 4 or 5 of the TRP A 901 during the beam failure recovery process, a beam failure may not occur on the communication link between the TRP B 902 and the UE panel B of terminal 911 and the communication link between the TRP C 903 and the UE panel C of terminal 911. In addition, even if the TRP A 901 selects either the beam index 4 or 5 of the TRP A 901 during the beam failure recovery process, performance degradation of the communication link between the TRP B 902 and the UE panel B of terminal 911 and the communication link between the TRP C 903 and the UE panel C of terminal 911 may be the least.

Meanwhile, the messages of steps S1910a and S1910b may be configured differently depending on the base station(s) to which the TRP A 901, TRP B 902, and TRP C 903 are connected. For example, if the TRP B 902 and TRP C 903 are connected to the same base station as the base station to which the TRP A 901 is connected, the TRP B 902 and TRP C 903 may transmit index(es) of beam(s) of the TRP A 901 that satisfy their SINR thresholds to the terminal 911 through an RRC signaling newly defined to transmit such information described in the present disclosure.

If the TRP B 902 and TRP C 903 are connected to base station(s) different from the base station to which the TRP A 901 is connected, the TRP B 902 and TRP C 903 may transmit the information to the terminal 911 through a Msg2 or MsgB of a RACH procedure or through SRB3 signaling newly defined to transmit such information described in the present disclosure.

The information transmitted in FIG. 19 based on the above description may be exemplified as shown in Table 11 below.

TABLE 11

Delivered information

| TRP B → UE panel | Beam indexes = 3, 4, 5 | |
|---|---|---|
| B | | |
| TRP C → UE panel | Beam indexes = 2, 4, 5 | |
| C | | |
| | Scheme 1 | Scheme 2 |
| UE panel A → TRP | TRP ID = B, beam | Beam indexes = 4, 5 |
| A | indexes = 3, 4, 5 | |
| | TRP ID = C, beam | |
| | indexes = 2, 4, 5 | |

As exemplified in Table 11, the terminal 911 may transmit both the TRP IDs and the index(es) of beam(s) transmitted by the corresponding TRPs in the message transmitted to the TRP A 901 as in Scheme 1. In Scheme 1, the amount of information that the terminal 911 needs to transmit increases, but the terminal 911 may transmit the information without processing thereon.

In addition, in Scheme 2, the terminal 911 may identify the index(es) of beam(s) informed by the TRP B 902 and the index(es) of beam(s) informed by the TRP C 903, and select common beam indexes. Then, the terminal 911 may transmit only the common beam indexes to the TRP A 901. When using Scheme 2, the terminal 911 may need to process the information transmitted by the TRP B 902 and TRP C 903. Therefore, the processing load on the terminal 911 may increase. However, Scheme 2 has the advantage of reducing the amount of information that the terminal 911 transmits to the TRP A 901.

On the other hand, the message that the terminal 911 reports to the TRP A 901 may vary based on a type of the message received from the TRP A 901. For example, When information instructing to report index(es) of beam(s) satisfying the SINR thresholds of other TRPs was received from the TRP A 901 through UEInformationRequest of RRC signaling in FIG. 17 above, the terminal 911 may transmit the information obtained from the TRP B 902 and TRP C 903 to the TRP A 901 through UEInformationResponse.

As another example, in order to report the index(es) of beam(s) satisfying the SINR thresholds of other TRPs to the TRP A 901, the terminal 911 may use UCI, measurement report, UE assistance information, or RRC signaling newly defined to transmit such information according to the present disclosure.

As another example, the information reporting procedure of the terminal 911 may use a Msg1 or MsgA of a RACH procedure. As another example, the terminal 911 may transmit the information using SN measurement report or SN UE assistance information through SRB3, or SRB3 signaling newly defined to transmit such information according to the present disclosure.

Meanwhile, the exemplary embodiment of FIG. 19 described above may be used in combination with at least one of the exemplary embodiments of FIG. 16 to FIG. 18 described above and/or other exemplary embodiments described below.

FIG. 20 is a signal flow diagram for a process in which a terminal where a beam failure occurred receives information for beam failure recovery from adjacent TRP(s) according to the present disclosure in the MTRP NCJT environment.

As shown in FIG. 20, the TRP A 901, TRP B 902, and TRP C 903 are illustrated as described in FIGS. 9 to 19. However, like the cases described in FIGS. 16 to 19, FIG. 20 assumes that the TRP A 901, TRP B 902, and TRP C 903 cannot transmit and receive data via a backhaul connected either directly or through base stations.

FIG. 20 may correspond to a case where the terminal 911 is an entity of determining a beam that can guarantee the performance of the communication links previously established by other TRP(s) and the terminal 911 among the candidate beams formed by the TRP A 901 when a beam failure occurs on the communication link between the TRP A 901 and the UE panel A and beam failure recovery is performed.

The terminal 911 may have already measured SINRs of the communication link established with the TRP B 902 for the candidate beams of the TRP A 901 in FIG. 17 described above. In addition, the terminal 911 may have already measured SINRs of the communication link established with the TRP C 903 for the candidate beams of the TRP A 901. However, the terminal 911 cannot identify whether the measured SINRs satisfy the SINR thresholds required by the TRP B 902 and TRP C 903.

The operation of FIG. 20 may correspond to a procedure for obtaining information that can verify whether the SINRs measured from signals transmitted by the adjacent TRPs 902 and 903 communicating with the terminal 911 for the candidate beams of the TRP A 901 satisfy the respective SINR thresholds of the adjacent TRPs 902 and 903.

In step S2010a, the TRP C 903 may transmit the SINR threshold of the TRP C 903 to the terminal 911. In addition, in step S2010b, the TRP B 902 may transmit the SINR threshold of the TRP B 902 to the terminal 911. In this case, the SINR threshold of the TRP C 903 and the SINR threshold of the TRP B 902 may be the same value or different values. The SINR thresholds may be determined by considering various factors such as the performance of the devices constituting the TRPs or coverages of the TRPs, or may be determined according to the surrounding environment, and the like. As another example, the SINR thresholds of the TRPs may be determined based on actual measurements.

The SINR thresholds transmitted by the TRP B 902 and TRP C 903 to the terminal 911 may be exemplified as shown in Table 12 below.

TABLE 12

| | SINR threshold |
|---|---|
| TRP B → UE panel B | SINR_75 |
| TRP C → UE panel C | SINR_70 |

In addition, the procedure of FIG. 20 may be performed as a subsequent procedure of the preceding FIG. 17. As another example, the procedure of FIG. 20 may be a procedure in which all TRPs transmit their SINR thresholds to the terminal 911 when initiating the MTRP operations. If the procedure is such that all TRPs transmit their SINR thresholds to the terminal 911 when initiating the MTRP operation, the TRP A 901 may have transmitted its SINR threshold to the terminal 911 in advance in a step not illustrated in FIG. 20.

For example, when the terminal 911 initially establishes the communication link with the TRP A 901, the terminal 911 may receive information on the SINR threshold from the TRP A 901. Thereafter, when the TRP B 902 and TRP C 903 transmit additional data to the terminal 911, each of the TRP B 902 and TRP C 903 may transmit information on its own SINR threshold to the terminal 911. FIG. 20 may illustrate an example of such case.

As another example, if the entity that determines the performance of the communication links is the terminal 911, and a beam failure occurs between the terminal 911 and the TRP A 901, the terminal 911 may transmit a TRP ID of the TRP A 901 and a BFD indicator to the adjacent TRPs 902 and 903 as described above in FIG. 16. Therefore, if the entity that determines the performance of the communication links is the terminal 911, and information on the SINR thresholds is not received from each of the TRPs 901 to 903 in the initial procedure, the terminal 911 may request the SINR threshold of each TRP in step S1630. Therefore, the SINR thresholds may be received as a response to step S1630 in FIG. 20.

Meanwhile, if the procedure of FIG. 20 is performed as a response corresponding to step S1630 of FIG. 16, the SINR threshold request information of FIG. 16 may be transmitted to the adjacent TRPs 902 and 903 together with the TRP ID of the TRP A where the beam failure occurred and the BFD indicator.

If the TRP B 902 and TRP C 903 are connected to the same base station as the base station to which the TRP A 901 is connected, the terminal 911 may transmit the information described above to the TRP B 902 and TRP C 903 using UCI, UE assistance information, or RRC signaling newly defined according to the present disclosure.

On the other hand, if the TRP B 902 and TRP C 903 are connected to different base station(s) from the base station to which the TRP A 901 is connected, the terminal 911 may transmit the information described above to the TRP B 902 and TRP C 903 using a Msg1 or MsgA of a RACH procedure. As another example, if the TRP B 902 and TRP C 903 are connected to different base station(s) from the base station to which the TRP A 901 is connected, the terminal 911 may transmit the information described above to the TRP B 902 and TRP C 903 through SN UE assistance information of SRB3 or SRB3 signaling newly defined to transmit such information according to the present disclosure.

The SINR thresholds transmitted to the terminal 911 in FIG. 20 may also be transmitted differently depending on the connection relationship of the TRPs.

For example, if the TRP B 902 and TRP C 903 are connected to the same base station as the base station to which the TRP A 901 is connected, the TRP B 902 and TRP C 903 may transmit the SINR thresholds to the terminal 911 through DCI of the communication link established previously. As another example, if the TRP B 902 and TRP C 903 are connected to the same base station as the base station to which the TRP A 901 is connected, the TRP B 902 and TRP C 903 may transmit the SINR thresholds to the terminal 911 through a MeasConfig IE of RRC reconfiguration message or RRC signaling newly defined to transmit the SINR thresholds according to the present disclosure.

On the other hand, if the TRP B 902 and TRP C 903 are connected to different base station(s) from the base station to which the TRP A 901 is connected, the TRP B 902 and TRP C 903 may transmit the SINR thresholds to the terminal 911 through DCI, Msg2 or MsgB.

The terminal 911 may compare the SINR threshold of each TRP received in FIG. 20 with the SINRs of each of the TRP B 902 and TRP C 903 for the candidate beams of the TRP A, which are measured in FIG. 17 described above, to determine which beam of the TRP A to use.

Meanwhile, the exemplary embodiment of FIG. 20 described above may be used in combination with at least one of the exemplary embodiments of FIG. 16 to FIG. 19 described above and/or other exemplary embodiments described below.

FIG. 21 is a signal flow diagram for a process in which a terminal where a beam failure occurred determines beam failure recovery according to the present disclosure in the MTRP NCJT environment.

As shown in FIG. 21, the TRP A 901, TRP B 902, and TRP C 903 are illustrated as described in FIGS. 9 to 19. However, like the cases described in FIGS. 16 to 20, FIG. 21 assumes that the TRP A 901, TRP B 902, and TRP C 903 cannot transmit and receive data via a backhaul connected either directly or through base stations.

FIG. 21 corresponds to a signal flow diagram when beam failure recovery is performed for the communication link between the TRP A 901 and the UE panel A of terminal 911. In this case, the terminal 911 may be the entity that determines the performance of the communication link between the TRP B 902 and the UE panel B of terminal 911. In addition, the terminal 911 may be the entity that determines the performance of the communication link between the TRP C 903 and the UE panel C of terminal 911.

Through the procedure of FIG. 17 described above, the terminal 911 may have SINRs measured between the TRP B 902 and the UE panel B of terminal 911 for the respective candidate beams of the TRP A 901, and may have SINRs measured between the TRP C 903 and the UE panel C of terminal 911 for the respective candidate beams of the TRP A 901. In addition, through the procedure of FIG. 20 described above, the terminal 911 may have received the SINR threshold of TRP B 902 and the SINR threshold of TRP C 903.

In step S2110, the terminal 911 may select index(es) of beam(s) of the TRP A 901 by using the SINRs between the adjacent TRPs 902 and 903 and the terminal 911, which are measured for the respective candidate beams of the TRP A 901 in FIG. 17 and the SINR thresholds received from the TRPs 902 and 903. In this case, it may be assumed that the terminal 911 has measured the SINRs for the TRP B 902 and TRP C 903 as in Table 4 described above. In addition, it may be assumed that the SINR threshold condition of the TRP B 902 is that the SINR exceeds 75, and the SINR threshold condition of the TRP C 903 is that the SINR threshold exceeds 70.

In this case, the terminal 911 may determine the beam index 3, beam index 4, and beam index 5 as index(s) of beam(s) that satisfy the SINR threshold condition of the TRP B 902 among the candidate beams between the TRP A 901 and the UE panel A of terminal 911. In addition, the terminal 911 may determine the beam index 2, beam index 4, and beam index 5 as index(es) of beam(s) that satisfy the SINR threshold condition of the TRP C 903 among the candidate beams between the TRP A 901 and the UE panel A of terminal 911. The index(es) of beam(s) that satisfy the threshold condition may be index(es) of beam(s) that can guarantee the communication link between the terminal 911 and the specific TRP.

For example, among the candidate beams between the terminal 911 and TRP A 901, beams identified by the beam index 3, beam index 4, and beam index 5 may be beams that do not cause a beam failure of the communication link established between the TRP B 902 and terminal 911 or can minimize deterioration of communication quality in the communication link.

Similarly, among the candidate beams between the terminal 911 and TRP A 901, beams identified by the beam index 2, beam index 4, and beam index 5 may be beams that do not cause a beam failure of the communication link established between the TRP C 903 and terminal 911 or can minimize deterioration of communication quality in the communication link.

Therefore, the terminal 911 may confirm that index(es) of common beam(s) that satisfy both the thresholds of the TRP B 902 and TRP C 903 among the candidate beams between the terminal 911 and TRP A 901 are the beam index 4 and beam index 5.

In step S2120, the terminal 911 may transmit information on the index(es) of beam(s) of the TRP A that satisfy the SINR thresholds to the TRP A 901. The terminal 911 may transmit information on the index(es) of beam(s) of the TRP A that satisfy the SINR thresholds using either Scheme 1 or Scheme 2. This may be exemplified as shown in Table 13 below.

TABLE 13

Delivered information

| | Scheme 1 | Scheme 2 |
|---|---|---|
| UE panel A → TRP | TRP ID = B, beam | Beam indexes = 4, 5 |
| A | indexes = 3,4,5 | |
| | TRP ID = C, beam | |
| | indexes = 2,4,5 | |

As described above in Table 11, when using Scheme 1, since the terminal 911 transmits the information without any special processing, a load of the terminal 911 may be reduced. On the other hand, when using Scheme 2, the amount of information that the terminal 911 transmits to the TRP A 901 may be reduced.

Table 13 exemplifies a case where all beam indexes that the terminal 11 can select are transmitted. For example, in Scheme 1, the beam index 3, beam index 4, and beam index 5, which are beam indexes selected by the TRP B 902, are transmitted, and the beam index 2, beam index 4, and beam index 5, which are beam indexes selected by the TRP C 903, are transmitted. On the other hand, in Scheme 2, the beam index 4 and beam index 5, which are common beam indexes of the indexes of beams selected by the TRP B 902 and the indexes of beams selected by the TRP C 903, may be transmitted

However, as another example, the terminal 911 may select a specific beam based on index(es) of preferred beam(s). In this case, Scheme 2 may be used to transmit only one preferred beam index, either beam index 4 or beam index 5. As another example, the index(es) of beam(s) may be transmitted as in Scheme 2, but the beam index preferred by the terminal 911 may be transmitted together. When the terminal 911 transmits the preferred beam index to the TRP A 901, the terminal 911 may also be configured to transmit the preferred beam index together even in the case of Scheme 1.

Meanwhile, step S2120 may be performed in response to the indexes of beams of the TRP A, which are transmitted by the TRP A 901 to terminal 911 in step S1710 of FIG. 17. Therefore, the message transmitted in step S2120 may be determined based on a type of the message transmitted in the preceding step S1710.

For example, if the information instructing to report index(es) of beam(s) that satisfy the SINR threshold of another TRP is received through UEInformationRequest of RRC signaling in step S1710, the terminal 911 may transmit the corresponding information to the base station through UEInformationResponse in step S2120 in response to the instructing information.

As another example, the terminal 911 may transmit information on index(es) of beam(s) that satisfy the SINR threshold of another TRP to the TRP A 901 using UCI, UE assistance information or RRC signaling newly defined to transmit such information according to the present disclosure.

As another example, the terminal 911 may transmit the information according to Scheme 1 or information according to Scheme 2 to the TRP A 901 using a Msg1 or MsgA of a RACH procedure.

As another example, the terminal 911 may transmit the information according to Scheme 1 or information according to Scheme 2 to the TRP A 901 using SN UE assistance information through SRB3 or using SRB3 signaling newly defined to transmit such information according to the present disclosure.

Meanwhile, the exemplary embodiment of FIG. 21 described above may be used in combination with at least one of the exemplary embodiments of FIG. 16 to FIG. 20 described above and/or other exemplary embodiments described below.

FIG. 22 is a flowchart according to a procedure for determining a beam to be used for beam failure recovery when a beam failure occurred according to the present disclosure in the MTRP NCJT environment.

As shown in FIG. 22, the TRP A 901, TRP B 902, and TRP C 903 are illustrated as described in FIGS. 9 to 19. However, like the cases described in FIGS. 16 to 21, FIG. 22 assumes that the TRP A 901, TRP B 902, and TRP C 903 cannot transmit and receive data via a backhaul connected either directly or through base stations.

FIG. 22 illustrates a process for the TRP A 901 where a beam failure occurred to select an optimal beam considering the performance of the communication links between the terminal 911 and other TRPs and the performance of the communication link between itself and the terminal when selecting a beam to be used for communication.

Therefore, the TRP A 901 may have received index(es) of beam(s) that can guarantee the performance of the communication link between the TRP B 902 and the UE panel B of terminal 911 among the candidate beams formed by the TRP A 901 for the UE panel A of terminal 911 through Scheme 1 or Scheme 2 of the process of FIG. 21. In addition, the TRP A 901 may have received index(es) of beam(s) that can guarantee the performance of the communication link between the TRP C 903 and the UE panel C of terminal 911 among the candidate beams formed by the TRP A 901 for the UE panel A of terminal 911 through Scheme 1 or Scheme 2 of the process of FIG. 21.

The TRP A 901 may select an index of a beam to be used for communication with the terminal 911 based on the above information. In this case, the TRP A 90 may select the index of the beam considering the performance of the communication link between the TRP A 901 and terminal 911. In addition, the TRP A 901 may select the index of the beam to be used for communication with the terminal 911 considering th performance of communication link(s) with other terminals.

If the terminal 911 transmits information on index(es) of beam(s) that satisfy the SINR thresholds and information on TRP IDs corresponding thereto using Scheme 1 in the procedure of FIG. 21, the TRP A 901 may know which beam indexes satisfy the thresholds of the TRP B 902 and TRP C 903 satisfy, respectively. Therefore, the TRP A 901 may select an index of a beam that the TRP A 901 will finally use for the UE panel A of terminal 911 based on the information described above.

If the terminal 911 transmits only the indexes of common beams that satisfy both the SINR thresholds of the TRP B 902 and TRP C 903 to the TRP A 901 using Scheme 2 in the procedure of FIG. 21, the TRP A 901 may select an index of a beam that the TRP A 901 will finally use for the UE panel A of terminal 911 based on the corresponding information.

Consequently, in the case of FIG. 21, during the process of selecting the final beam index to be used while performing the beam failure recovery process with the UE panel A of terminal 911, the TRP A 901 may receive index(es) of beam(s) of the TRP A 901 that satisfy a certain level or higher communication performance from the TRP B 902 and TRP C 903. Then, the TRP A 901 may select the best beam among the received index(es) of beam(s) of the TRP A 901.

The combinations of beams selectable by the TRP A 901 based on the SINR values of Scheme 1 and Scheme 2 may be exemplified as in Table 14 below.

TABLE 14

| Beam indexes | | Scheme 1 | | Scheme 2 |
|---|---|---|---|---|
| of TRP A | SINR | TRP B | TRP C | TRP B & TRP C |
| Beam index = 1 | SINR_80 | unsatisfied | unsatisfied | unsatisfied |
| Beam index = 2 | SINR_65 | unsatisfied | satisfied | unsatisfied |
| Beam index = 3 | SINR_85 | satisfied | unsatisfied | unsatisfied |
| Beam index = 4 | SINR_70 | satisfied | satisfied | satisfied |
| Beam index = 5 | SINR_75 | satisfied | satisfied | satisfied |

Meanwhile, the exemplary embodiment of FIG. 22 described above may be used in combination with at least one of the exemplary embodiments of FIG. 16 to FIG. 21 described above.

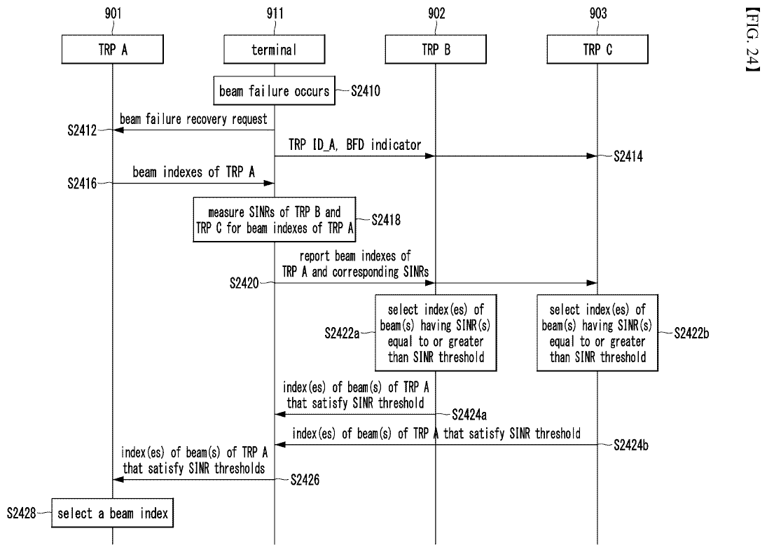

FIG. 23 is a flowchart for a process in which beam failure recovery is performed according to an exemplary embodiment of the present disclosure in the MTRP NCJT environment.

In describing FIG. 23, the TRP A 901, TRP B 902, TRP C 903, and terminal 911 described in FIG. 16 to FIG. 22 will be used for the description. Since they operate in the MTRP NCJT environment, it is assumed that data cannot be transmitted and received via a backhaul connected either directly or through base stations.

As shown in FIG. 23, in step 2310, the terminal 911 may transmit information on a beam failure to the TRP B 902 and TRP C 903, and measure SINRs for signals from the TRP B 902 and TRP C 903. In this case, the beam failure may be a beam failure between the TRP A 901 and terminal 911. Therefore, the terminal 911 may transmit a TRP ID of the TRP A 901 to the TRP B 902 and TRP C 903 to inform of the beam failure with the TRP A 901. In addition, when the terminal 911 measures the SINRs of signals received from the TRP B 902 and TRP C 903, the terminal may measure the SINRs for indexes of candidate beams of the TRP A 901. Although not illustrated in FIG. 23, the terminal 911 may have received information on the indexes of candidate beams of the TRP A 901 from the TRP A 901. In addition, the terminal 911 may report the SINRs measured from the TRP B 902 to the TRP B 902. In this case, the SINRs reported by the terminal 911 to the TRP B 902 may be SINRs measured on the communication link between the TRP B 902 and terminal 911 for the respective candidate beams between the terminal 911 and TRP A 901, and the SINRs reported by the terminal 911 to the TRP C 903 may be SINRs measured on the communication link between the TRP C 903 and terminal 911 for the respective candidate beams between the terminal 911 and TRP A 901.

As shown in FIG. 23, one of two types may be determined depending on the entity of determining an index of a beam for beam failure recovery after step 2310.

If the TRP determines an index of a beam to be used for beam failure recovery, steps 2320 and 2330 may be performed. On the other hand, if the terminal determines an index of a beam index to be used for beam failure recovery, steps 2340, 2350, and 2360 may be performed.

First, the case where the TRP determines an index of a beam to be used for beam failure recovery will be described.

In step 2320, the terminal 911 may transmit information on index(es) of beam(s) that satisfy the SINR thresholds of the respective TRPs 902 and 903 based on the SINR thresholds received from the TRP B 902 and TRP C 903 in step 2310 to the TRP A 901 using one of Scheme 1 or Scheme 2 as described above in Table 11. The operation of step 2320 may be correspond to an operation in which each of the TRP B 902 and TRP C 903 transmits information on index(es) of beam(s) that satisfy the SINR threshold to the TRP A 901 through the terminal 911.

In step 2330, the TRP A 901 may select a beam with the highest SINR as a beam to be used for beam failure recovery between the terminal 911 and TRP A 901 based on the index(es) of beam(s) that satisfy the SINR thresholds, which are received from the terminal 911.

Hereinafter, the case where the terminal determines an index of a beam to be used for beam failure recovery will be described.

In step 2340, the terminal 911 may receive the SINR threshold from each of the TRP B 902 and TRP C 903. In other words, the terminal 911 may request the SINR threshold from the TRP B 902 and receive the SINR threshold of the TRP B 902 from the TRP B 902. In addition, the terminal 911 may request the SINR threshold from the TRP C 903 and receive the SINR threshold of the TRP C 903 from the TRP C 903.

In step 2350, the terminal 911 may determine index(es) of beam(s) based on the SINR threshold received from each of the TRP B 902 and TRP C 903. In other words, the terminal 911 may determine index(es) or beam(s) having SINR(s) that exceed (or are equal to or higher than) the SINR threshold from among SINRs measured on the communication link between TRP B 902 and the terminal 911 for the respective candidate beams between the terminal 911 and TRP A 901 described in step 2310 above. Index(es) of beam(s) may be determined for the TRP C 903 in the same manner. Accordingly, the terminal 911 may transmit information on the index(es) of beam(s) to the TRP A 901 using Scheme 1 or Scheme 2 described in FIG. 21.

In step 2350, the TRP A 901 may receive, from the terminal 911, information on index(es) of beam(s) that can maintain the communication links of the adjacent TRPs 902 and 903 communicating with the terminal 911 using Scheme 1 or Scheme 2.

In step 2360, the TRP A 901 may select an index of a beam with the highest SINR based on the index(es) of beam(s) received from the terminal 911.

The above-described FIG. 23 may correspond to one exemplary embodiment based on the above-described FIG. 16 to FIG. 22.

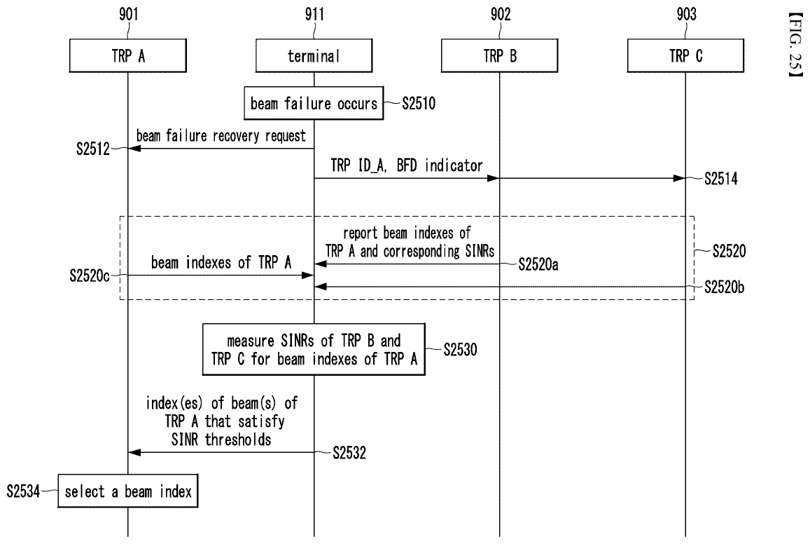

FIG. 24 is a signal flow diagram for a process in which a TRP where a beam failure occurred performed beam recovery according to the present disclosure in the MTRP NCJT environment.

FIG. 24 may be a flow diagram based on a specific combination of the above-described FIGS. 16 to 22.

Steps S2410, S2412 and S2414 may correspond to steps S1610, S1620 and S1630 described in FIG. 16, respectively. Steps S2416 and S2418 may correspond to steps S1710 and S1720 described in FIG. 17, respectively. In addition, step S2420 may correspond to steps S1810a and S1810b described in FIG. 18, and steps S2422a and S2422b may correspond to steps S1820a and S1820b described in FIG. 18, respectively.

Steps S2424a and S2424b may correspond to steps S1910a and S1910b described in FIG. 19, and step S2426 may correspond to step S1920 described in FIG. 19. Step S2428 may correspond to step S2210 described in FIG. 22.

Therefore, the exemplary embodiment of FIG. 24 may be an exemplary embodiment in which the procedures of FIG. 16 to FIG. 19 described above are sequentially performed and then the procedure of FIG. 22 is performed. In addition, the exemplary embodiment of FIG. 24 may be an exemplary embodiment in which the TRP operates as the entity determining an index of a beam to be used for beam failure recovery.

FIG. 25 is a signal flow diagram for a process in which a terminal where a beam failure occurred performs beam failure recovery according to the present disclosure in the MTRP NCJT environment.

FIG. 25 may be a flowchart based on a specific combination of FIGS. 16 to 22 described above.

Steps S2510, S2512, and S2514 may correspond to steps S1610, S1620, and S1630 described in FIG. 16, respectively. In addition, step S2520 may be a procedure that combines FIGS. 17 and 20 described above.

For example, step S2520c may correspond to step S1710 of FIG. 17 described above. Therefore, step S1720 of FIG. 17 may be omitted. Steps S2520a and S2520b may correspond to steps S1910a and S1910b described in FIG. 20, respectively.

In addition, steps S2530 and S2532 may correspond to steps S2110 and S2120 of FIG. 21 described above, respectively. Step S2534 may correspond to step S2210 described in FIG. 22.

Therefore, the exemplary embodiment of FIG. 25 may be an exemplary embodiment in which the procedures of FIG. 17 and FIG. 20 are performed after the procedure of FIG. 16 described above, and then the procedures of FIG. 21 and FIG. 22 are performed. In addition, the exemplary embodiment of FIG. 25 may be an exemplary embodiment in which the terminal operates as an entity that determines an index of a beam to be used for beam failure recovery.

FIGS. 24 and 25 described above may be one example that combines the procedures of FIGS. 16 to 22 described above. Therefore, in addition to the methods illustrated in FIGS. 24 and 25, various methods using the procedures of FIGS. 16 to 22 may be used. In addition, at least one of the procedures of FIGS. 16 to 22 may be used in combination with other types of operations not exemplified in the present disclosure.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a terminal, comprising:
in response to occurrence of a beam failure with a first transmission and reception point (TRP) communicating with the terminal, transmitting a beam failure recovery request to the first TRP;
transmitting, to a second TRP communicating with the terminal, a first message including an identifier (ID) of the first TRP and a beam failure detection (BFD) indicator;
receiving, from the first TRP, a second message including respective beam indexes corresponding to candidate beams to be used between the first TRP and the terminal;
measuring signal to interference plus noise ratios (SINRs) of a first link communicating with the second TRP for the respective beam indexes;
in response to the first message, receiving, from the second TRP, a third message including an SINR threshold of the first link; and
in response to the second message, transmitting, to the first TRP, a first report message including information related to index(es) of beam(s) satisfying the SINR threshold of the first link.

2. The method according to claim 1, further comprising:
in response to existence of a third TRP communicating with the terminal, transmitting, to the third TRP, a fourth message including the ID of the first TRP and a BFD indicator;
measuring SINRs of a second link communicating with the third TRP for the respective beam indexes; and
in response to the fourth message, receiving, from the third TRP, a fifth message including an SINR threshold of the second link,
wherein the first report message further includes information related to index(es) of beam(s) satisfying the SINR threshold of the second link.

3. The method according to claim 2, wherein the first report message includes an ID of the second TRP, the index(es) of beam(s) satisfying the SINR threshold of the first link, an ID of the third TRP, and the index(es) of beam(s) satisfying the SINR threshold of the second link.

4. The method according to claim 2, wherein the first report message includes common index(es) of the index(es) of beam(s) satisfying the SINR threshold of the first link and the index(es) of beam(s) satisfying the SINR threshold of the second link.

5. The method according to claim 1, wherein each of the second message and the first report message is transmitted and received using a radio resource control (RRC) signaling message.

6. The method according to claim 1, wherein when the first TRP and the second TRP are connected to a same base station, the first message is transmitted using one of uplink control information (UCI), measurement report, or user equipment (UE) assistance information.

7. The method according to claim 1, wherein when the first TRP and the second TRP are connected to different base stations, the first message is transmitted using a message based on a random access channel (RACH) access procedure.

8. A method of a first transmission and reception point (TRP), comprising:
upon receiving a beam failure recovery request from a terminal communicating with the first TRP, checking whether the first TRP is connected to a second TRP communicating with the terminal via a backhaul;
in response to the first TRP not being connected to the second TRP via a backhaul, transmitting, to the terminal, a first message including beam indexes of candidate beams between the first TRP and the terminal:
in response to the first message, receiving, from the terminal, a first report message including information related to index(es) of beam(s); and
determining an index of a beam to be used for communicating with the terminal based on the information related to the index(es) of beam(s).

9. The method according to claim 8, wherein the first report message includes an identifier (ID) of the second TRP and index(es) of at least one beam satisfying a signal to interference plus noise ratio (SINR) threshold of a first link between the second TRP and the terminal.

10. The method according to claim 9, wherein when a third TRP communicating with the terminal exists, the first report message further includes an ID of the third TRP ID and index(es) of at least one beam satisfying an SINR threshold of a second link between the third TRP and the terminal.

11. The method according to claim 8, wherein when the first report message includes two or more beam indexes, the index of the beam to be used for communicating with the terminal is determined based on SINRs reported with the respective two or more beam indexes.

12. The method according to claim 8, wherein each of the first message and the first report message is transmitted and received using a radio resource control (RRC) signaling message.

13. A method of a terminal, comprising:
in response to occurrence of a beam failure with a first transmission and reception point (TRP) communicating with the terminal, transmitting a beam failure recovery request to the first TRP;
transmitting, to a second TRP communicating with the terminal, a first message including an identifier (ID) of the first TRP and a beam failure detection (BFD) indicator;
receiving, from the first TRP, a second message including respective beam indexes corresponding to candidate beams to be used between the first TRP and the terminal;
measuring signal to interference plus noise ratios (SINRs) of a first link communicating with the second TRP for the respective beam indexes;
transmitting, to the second TRP, a third message including the measured SINRs for the respective beam indexes;
in response to the first message, receiving, from the second TRP, a fourth message including index(es) of at least one beam; and
transmitting, to the first TRP, a first report message including information related to index(es) of beam(s) based on the fourth message received from the second TRP.

14. The method according to claim 13, further comprising:
in response to existence of a third TRP communicating with the terminal, transmitting, to the third TRP, a fifth message including the ID of the first TRP and a BFD indicator;
measuring SINRs of a second link communicating with the third TRP for the respective beam indexes;
transmitting, to the third TRP, a sixth message including the measured SINRs for the respective beam indexes; and
in response to the fifth message, receiving, from the third TRP, a seventh message including index(es) of at least one beam,
wherein the first report message further includes information related to index(es) of beam(s) based on the seventh message.

15. The method according to claim 14, wherein the first report message includes an ID of the second TRP, index(es) of beam(s) satisfying the SINR threshold of the first link, an ID of the third TRP, and index(es) of beam(s) satisfying the SINR threshold of the second link.

16. The method according to claim 14, wherein the first report message includes only common index(es) of the index(es) of at least one beam included in the fourth message and the index(es) of at least one beam included in the seventh message.

17. The method according to claim 13, wherein each of the second message and the first report message is transmitted and received using a radio resource control (RRC) signaling message.

18. The method according to claim 13, wherein when the first TRP and the second TRP are connected to a same base station, the first message is transmitted using one of uplink control information (UCI), measurement report, or user equipment (UE) assistance information.

19. The method according to claim 13, wherein when the first TRP and the second TRP are connected to different base stations, the first message is transmitted using a message based on a random access channel (RACH) access procedure.
